(19) United States
(12) Patent Application Publication
(10) Pub. No.: US 2025/0205717 A1
(43) Pub. Date: Jun. 26, 2025

(54) METHOD AND APPARATUS FOR ACHIEVING HIGH ELECTROSPRAY DEPOSITION EFFICIENCY ON LOW AREA TARGETS

(71) Applicant: Rutgers, The State University of New Jersey, New Brunswick, NJ (US)

(72) Inventors: Jonathan SINGER, Cranford, NJ (US); Sarah PARK, Piscataway, NJ (US)

(21) Appl. No.: 18/846,353

(22) PCT Filed: Mar. 17, 2023
(86) PCT No.: PCT/US23/15483

§ 371 Date: Sep. 12, 2024

Related U.S. Application Data
(60) Provisional application No. 63/269,493, filed on Mar. 17, 2022.

(51) Int. Cl. B05B 5/025; B05B 5/08

(52) U.S. Cl. CPC B05B 5/0255; B05B 5/087

(57) ABSTRACT

A method, including: establishing an electric field (210) in an electrospray deposition device (100B) and within the electric field emitting a spray of a medium (114) comprising payload materials (116A) from an emitter (104) toward a conductive target (132) disposed on an insulated conductive body (200); disposing charged payload materials (116BE) on the insulated conductive body; and establishing field lines (130BE) in the electric field between the emitter and the charged payload materials on the insulated conductive body to stabilize the electric field and between the emitter and the target to carry the spray of the medium to the target.

This application is a National Stage entry of PCT/US23/15483, filed Mar. 17, 2023, which claims benefit of U.S. Patent Application No. 63/269,493, filed Mar. 17, 2023. The entire contents of these applications are hereby incorporated by reference as if fully set forth herein.

### STATEMENT REGARDING FEDERALLY SPONSORED DEVELOPMENT

This invention was made with government support under Grant No. 1911518 awarded by the National Science Foundation. The government has certain rights in the invention.

### BACKGROUND

Micro/nanoscale conformal coatings can be applied in either the molecular or condensed state. Molecular deposition techniques, such as electrodeposition, vacuum deposition, atomic layer deposition, or chemical vapor deposition, generally require either a fluid bath or high-vacuum to apply and may also require high-temperature precursor processing. This offsets their cost-benefit considerations and limits the size of the component that can be coated. Condensed deposition techniques, such as spray coating, dip coating, spin coating, and brush or blade coating struggle with 3D surfaces and result in capillary or shadowing effects.

Widespread use of additive manufacturing is increasing exponentially. Industries using additive manufacturing include: aerospace, agriculture, architecture, engineering, construction, automotive, consumer products, education, high tech, industrial equipment, biomedical implants, prosthetics, dental, jewelry, electronics. Various industries utilize additive manufacturing to design and build prototypes, tooling and end-use parts. Existing additive manufacturing techniques rely on the material ejection apparatus to direct the material being printed to the desired target location and do not provide any mechanism to redirect material away from its ejection vector toward uncoated regions of the target location. Furthermore, according to existing methods, if a 3D printed component is to be coated it would be done in an entirely different process.

### SUMMARY

Various embodiments relate to a method and apparatus for achieving high electrospray deposition efficiency on low area targets. The method may include establishing an electric field in an electrospray deposition device and within the electric field emitting a spray of a medium including payload materials from an emitter toward a conductive target disposed on an insulated conductive body; disposing charged payload materials on the insulated conductive body; and establishing field lines in the electric field between the emitter and the charged payload materials on the insulated conductive body to stabilize the electric field and between the emitter and the target to carry the spray of the medium to the target.

According to various embodiments, the method may further include disposing the charged payload materials on the insulated conductive body by causing an initial overspray of the medium including the charged payload materials to reach the insulated conductive body.

According to various embodiments, the method may further include ensuring insulation on the insulated conductive body permits field lines to form between the charged payload materials on the insulated conductive body and a conductive body of the insulated conductive body when the electric field is present.

According to various embodiments, the method may further include holding the conductive body at a relatively lower or higher potential difference with the emitter as compared to the target.

According to various embodiments, the method may further include grounding the conductive body.

According to various embodiments, the method may further include ensuring that field lines between the emitter and the charged payload materials on the insulated conductive body fully surround the target.

According to various embodiments, the method may further include directing the spray of the medium with the field lines between the emitter and the target.

According to various embodiments, the method may further include applying a mask to a portion of the target.

According to various embodiments, the method may further include aligning the spray of the medium with the field lines between the emitter and the target; and ensuring that field lines between the emitter and the mask are less dense than field lines between the emitter and the charged payload materials on the insulated conductive body to: 1) isolate the field lines between the emitter and an unmasked portion of the target from other field lines; 2) aid in concentrating the spray of the medium within the field lines between the emitter and the unmasked portion of the target; and 3) thereby focus the spray of the medium on the unmasked portion of the target.

According to various embodiments, the method may further include ensuring a mass of a conductive body of the insulated conductive body is at least 1,000 times a mass of the target.

According to various embodiments, the method may include establishing an electric field in an electrospray deposition apparatus between an emitter and an insulated conductive body; disposing a target on the insulated conductive body; emitting a spray of a medium toward the target; and causing an initial overspray of the spray to reach the insulated conductive body.

According to various embodiments, the method may further include causing the initial overspray to reach a mask on the target.

According to various embodiments, the insulated conductive body establishes an insulated body profile as seen by the emitter; and the method further including ensuring the target is disposed fully within the insulated body profile as seen by the emitter.

According to various embodiments, the method may further include maintaining a distance of at least 1 centimeter between the target as seen by the emitter and an entirety of a perimeter of the insulated body profile.

According to various embodiments, the insulated body profile establishes an insulated body profile area: the target establishes a target profile as seen by the emitter; and the target profile establishes a target profile area; and the method further includes ensuring the insulated body profile area is at least 100 times the target profile area.

According to various embodiments, the method may further include ensuring a mass of a conductive body of the insulated conductive body is at least 1000 times a mass of the target.

Various embodiments of the method may include subjecting a flow of a medium from a capillary to a relatively high electric field to form a spray of droplets of the medium; directing the spray toward a target disposed on an insulated surface that is disposed on a conductive body that is held at an electric potential difference with the medium in the capillary; causing initial overspray of the spray; and ensuring the initial overspray lands on the insulated surface adjacent the target.

According to various embodiments, the method may include subjecting a flow of a medium from a capillary to a relatively high voltage to form a spray of droplets of the medium; directing the spray toward a target disposed on an insulated surface that is disposed on a conductive body that is held at a relatively low voltage; causing initial overspray of the spray; and ensuring the initial overspray lands on the insulated surface adjacent the target.

According to various embodiments, the method may further include ensuring the initial overspray surrounds around an entire perimeter of the target.

According to various embodiments, the method may further include ensuring the overspray is disposed in an electric field generated by the relatively high potential difference.

According to various embodiments, the potential difference results from a grounded body.

According to various embodiments, the method may further include applying a prespray to the target and the insulated surface to dissipate or apply charge.

According to various embodiments, the method may further include focusing the spray using a focus ring disposed around the spray.

According to various embodiments, an apparatus includes an electrospray deposition emitter configured to generate a spray of a medium toward a target and to be held at or above a first electric potential magnitude; and an extract or target comprising: an electrically conductive body configured to be held at a lower or higher electric potential magnitude than the first electric potential magnitude and to define a support face; insulation on the support face; and electrically charged payload materials disposed on the support face.

According to various embodiments, the first potential is configured to generate an electric field, and the electric field is sufficient to cause the field lines to form between the electrically charged payload materials and the electrically conductive body.

According to various embodiments, the electrically conductive body is grounded.

According to various embodiments, the apparatus may further include a focus ring configured to constrict the spray radially inward as the spray passes through the focus ring.

According to various embodiments, the apparatus may further include a controller configured to control at least one of the first voltage potential and a flow rate of the medium.

According to various embodiments, an apparatus may include a capillary configured to pass emit therefrom a flow of a medium; an extractor target including an electrically conductive body configured to define a support face facing the capillary, and insulation on the support face; and a high voltage source configured to generate an electric potential that will disperse the flow exiting the capillary into a spray of charged droplets directed toward the support face; and configured to generate an electric field between the capillary and a target on the support face at a different electric potential; where the electrically conductive body of the extractor target is configured to be held at an electrical potential that is below a relatively high voltage generated by the high voltage source.

According to various embodiments, the apparatus may be further configured to cause an initial overspray of the spray to reach the support face; and the electric field is configured to generate field lines between the capillary and medium from the overspray disposed on the support face.

According to various embodiments, the apparatus may further include a controller configured to control the generation of at least one of the electric fields and a flow rate of the medium.

According to various embodiments, the apparatus may include a capillary configured to pass emit therefrom a flow of a medium; an extractor target including an electrically conductive body configured to define a support face facing the capillary, and insulation on the support face; and a high voltage source configured to disperse the flow exiting the capillary into a spray of charged droplets directed toward the support face; and configured to generate an electric field between the capillary and a target on the support face at a relatively low voltage; where the electrically conductive body of the extractor target is configured to be held at an electrical potential that is below the relatively high voltage.

According to various embodiments, the apparatus may be further configured to cause an initial overspray of the spray to reach the support face; and the electric field is configured to generate field lines between the capillary and medium from the overspray disposed on the support face.

Still other aspects, features, and advantages are readily apparent from the following detailed description, simply by illustrating a number of particular embodiments and implementations, including the best mode contemplated for carrying out the invention. Other embodiments are also capable of other and different features and advantages, and its several details can be modified in various obvious respects, all without departing from the spirit and scope of the invention. Accordingly, the drawings and description are to be regarded as illustrative in nature, and not as restrictive.

Electrospray deposition (ESD) is a common thin film coating technique that can produce charged droplets at the micro- and nano-scale capable of being used in medicine, such as for drug delivery purposes and medical implants. In ESD, an electrostatic force is applied to a solution, which then disperses charged droplets loaded with the materials to be deposited. A mode of ESD includes self-limiting electrospray deposition (SLED). In SLED, the material arrives onto a target as a dried spray, carrying a charge that eventually begins to repel itself over time. The charged spray is redirected to regions that are uncoated such that manipulation of the electrostatic repulsion, hydrodynamic forces, and evaporation kinetics can be employed to conformally cover 3D architectures with micro-coatings. The generated coatings are hierarchical, possessing either nano-shell, nanoparticle, or nanowire microstructures, which can be smoothed through further post processing. SLED may be a replacement for dip or conventional-spray coating. An advantage may be the potential for much higher materials utilization. While many studies have presumed high efficiency in ESD, this is rarely quantified. Here, it is shown how architecting the local “charge landscape” can lead to SLED coatings approaching 100% deposition efficiency on microneedle arrays (MRA) and other complex substrates of relevant therapeutics and model materials, including biocompatible polymers, proteins, and bioactive small molecules.

Electrostatic spray is an efficient coating method that has traditionally been used in the automotive and agricultural industry to coat large surfaces (#93). More recently, the related technique of electrospray deposition (ESD), which has been primarily utilized for analytical metrology, has significantly expanded in the manufacturing space. Due to the high controllability of thin film coatings produced by ESD, it has been utilized where micro- and nano-scale coatings are needed. As one example, ESD has been able to fabricate organic photovoltaic cells (OPVs) and achieve high power conversion efficiency via optimization of solvent evaporation (#94, #95). ESD provides an additional avenue for the rapid and facile manufacturing of organic light-emitting diodes which can then satisfy the demand in the full-color display industry (#96). Due to its ease of thin film production, ESD offers as an alternative thin film coating method in biotechnology as well. As mentioned, altering the ESD parameters allows for the manipulation of the droplet morphology, more specifically the droplet diameter. Nanoparticles (NPs) are significant in the biomedical field for drug delivery applications, and NPs can be quickly produced via ESD. Such applications for NPs include electrospraying chitosan NPs (#97) and collagen NPs (#98) as drug delivery carriers (#97, 98) and spraying polycaprolactone NPs layers to control alignment and growth patterning for cell culture (#99). Collagen/calcium phosphate coatings onto metallic implants have been explored to encourage stronger chemical bonding between the implant and native bone tissue versus the metal to native tissue alone. (#100). Bioglass composed of silicon dioxide, calcium oxide, and phosphorous pentoxide was used to coat metallic implants via ESD for similar purposes of promoting osseointegration of the implant. (#101). ESD can also safely deposit protein nanoparticles while still demonstrating bioactivity after spraying (#102, 103).

By applying a high electric field onto a dilute solution, monodispersed charged droplets emerge from the needle tip and move toward a grounded target. (#44, #104, #105). The high electric field induces a shear force onto the solution, causing the solution to break apart into droplets reaching the micro- and nanoscale. More notably, a spray cone-jet mode maintains a Taylor cone at the tip of the nozzle which is stabilized by competing interactions between surface tension and coulombic forces. (#104).

The droplet diameter resulting from the cone-jet mode is a consequence of the solution properties in addition to its flow rate. (#44, #104, #106, #20):

$$d = α {( \frac{{Q}^{3} {ε}_{0} ρ}{{π}^{4} σ γ} )}^{\frac{1}{6}} + {d}_{0} \qquad ( 1 )$$

Where α is a constant related to the fluid's dielectric permittivity, Q is the flow rate, ε_0 is the permittivity of vacuum, ρ is the density of solution, γ is the surface tension of the solution, σ is the electrical conductivity of the solution, and d_0 is a relatively small diameter that comes into play only at low flow rates.

ESD in the stable cone-jet or even a more chaotic, but easier to stabilize multijet mode has several advantages when compared to other traditional methods of thin film coating and mechanical or acoustic atomizers. First, while concentrations are typically limited to dilute solutions, higher concentrations approaching 100% active material can be employed by using monomeric or other transforming materials as the spray material. In addition, many materials can be deposited, including particles, (poly-)peptides, sugars, (poly-)nucleic acids, polymers, and any other material that can be readily dispersed in a low viscosity fluid. Flow rates can vary from uL/h to ˜100 mL/h, with several technologies available for enhancing the flow rate including multiplexing (i.e., using arrays of needles) to using specially designed flow tips. Sprays can be conducted in various environments, including vacuum, and tuned through control of ambient humidity and temperature. Stimuli can be applied to the droplets in the air, including light (e.g., ultraviolet) which is used to induce chemistry, additional guiding electrical fields, magnetic fields, and acoustic fields. Relatively monodispersed droplets can be achieved in addition to droplet diameters as small as 100 nm. Further, charged droplets can obtain a higher deposition efficiency compared to a spray with droplets that are uncharged due to the non-inertial droplets following field lines to a grounded target. (#105, #106). For this reason, ESD (similar to electrostatic sprays) is considered to be a highly efficient deposition method with predicted efficiencies approaching 100%. This same advantage, however, can also lead to reduced efficiency through self-limiting effects. Here, self-limiting refers to experimental scenarios wherein the deposition of charge through ESD and lack of dissipation of this charge leads to the formation of a repulsive field that prevents further spray in that region. (#107) described two consequences of these effects: (1) when a specific target region received too much undissipated charge, the spray would either become unstable or find other grounded targets in the spray chamber, and (2) that a nonconductive material placed above a grounded target would quickly accumulate too much charge and begin to repel spray. (#107). An additional complication is the stability of the spray-any field created by the accumulation of charge at the target lowers the effective potential difference of the spray needle and the target, eventually removing the necessary conditions for the formation of a stable cone-jet spray mode. (#106). The accumulation of charge by insulating surfaces was recently quantified by Zhu and Chiarot, who demonstrated that the repulsive field can remain on the surface for experimentally-relevant times. (#108). The Inventor's work classified how these self-limiting effects could be exploited to conformally coat complex 3D objects when certain conditions of the spray solution were met. (#44, #104, #109). Specifically, the spray solution needs to arrive at the spray target as a non-conductive, glassy material. This regime is referred to as the self-limiting electrospray deposition (SLED).

Considered more generally, self-limiting effects fit into a larger family of ESD techniques wherein additional charged, or high-voltage, elements are incorporated to alter the field lines, or “charge landscape”, of the spray either statically or dynamically. The most ubiquitous approach is the use of guard rings whereby a more homogenous electric space is created in the inter-electrode region. Recent work has demonstrated the effectiveness of these rings using computational simulations, resulting in a more stable Taylor cone-jet mode. (#110). An intermediate voltage is applied to the guard rings to either extract or focus the spray plume. In the former case, the ring is placed near or even behind the needle tip to spread the plume. In the latter case, the ring is placed in front of the needle tip where the intermediate voltage disrupts the spatial electric potential to force the spray into a central reduced region. (#85, #86, #110). These can be considered far field means of controlling ESD. When the characteristic size of the target is larger than the spray plume, these methods can result in high efficiency. For example, Morozov et al. employed a far-field focusing approach to obtain 79±7% efficiency as measured by quartz crystal microbalance of protein sprays. (#103). There are also near-field approaches to controlling deposition, specifically the use of insulating materials placed immediately above the sample to first accumulate charge and then focus the spray through alteration of the charge landscape. In these near-field methods, the spray plume is most generally larger than the characteristic size of the template, and, while a high degree of control may be obtained of the spatial positioning of the deposited material, the efficiency of these sprays has only been limitedly evaluated and can be expected to be less than when larger targets are employed. Indeed, the only report known to the Inventors of deposition efficiency in near-field templates comes from recent work of Kingsley et al., where they showed that for a still macroscopic (3 mm thick) insulating mask, the deposition efficiency using a SLED compatible material was reported to be less than 5%, 26. (#77). All additional material ostensibly found other grounded targets in their spray chamber.

Here, the Inventors examine whether it is possible to manipulate the charge landscape to efficiently coat targets smaller than the characteristic plume size via manipulation of the charge landscape. If this were possible, ESD could potentially be employed as a precision coating alternative to two better-established techniques: dip coating and inkjet printing. Dip coating is a highly controlled means of depositing films down to the nanoscale but requires a standing reservoir of unused material and precise mechanical control of the objects to be coated. This is especially the case if only a certain portion of the target, such as a needle tip, is to be coated. In addition, if multiple layers are needed, a lengthy drying process between coats is sometimes required. (#112, #113). Inkjet printing can target specific portions of a target with sub-micron spatial resolution through the use of piezoelectric stages; however, this accuracy comes at the cost of it being a serial process requiring expensive positioning equipment. Further, geometries above “2.5D” complexities cannot be targeted by the line-of-sight nature of the jet, and capillary and gravity flow effects can lead to coating unwanted portions of the sample.27 In evaluating whether ESD can be a viable alternative to these methods, the Inventors have decided to focus on biologically relevant materials, where materials cost can often be a considerable driving factor. To do this, the Inventors have selected trehalose, a small molecule used as a matrix material, GLS-1027, a therapeutic small molecule, poly (vinyl pyrrolidone) (PVP), a biocompatible glassy polymer, poly (ethylene glycol) (PEG), a polymer melt, and trehalose-stabilized horse radish peroxidase (HRP), a protein complex, as model materials. These are merely examples of materials that could be employed and are not an exhaustive list of either materials or categories of materials that can be employed. It should be noted that of these, the PVP and the HRP (and by extension, its complex) are expected to be SLED coatings and, thereby, should rapidly accumulate repulsive charge. As a model geometry, the Inventors primarily employed a steel microneedle array (MNA) as 3D surface with total surface area orders of magnitude smaller than the plume size. The inventors also employed a small silicon chip (˜1 cm2) as another example geometry, though many other geometries which are commensurate to or less than the characteristic size of the spray plume could be employed. This includes complex 3D surfaces with reentrant geometries, especially when the spray is SLED in nature. Through image processing, it was determined that the surface area of the MNA was approximately 0.2 mm2/needle, as compared to a wafer spot size of ˜5 cm2 for the non-SLED samples at the same distance. In addition to their meeting the criteria for this study, MNAs are technologically relevant for dermal drug delivery. (#112, #113).

The general hypothesis (shown schematically in FIG. 5A) is that efficient sprays should: (1) start from a relatively “blank state” and not be affected by previous sprays; (2) be free from alternative targets: (3) employ a focus ring; and (4) have a large extractor ground (buried extractor target) placed behind, from the perspective of the spray, the target. The first three points have been justified in the discussion above and the use of the extractor ground serves a similar purpose as the extractor ring, stabilizing the spray by providing a persistent target. In addition, to maximize the effects of the deposited charge and minimize any effects that occurred after deposition, humidity was kept low for all sprays, which has previously been shown to amplify self-limiting effects in ESD (#115).

The results show that engineering the charge landscape to both focus and stabilize the spray can allow for high efficiency coatings for all explored materials and deposition rates, except for low viscosity melts, which are removed from the targets by dynamics that occur after deposition. This points to ESD with an engineered charge landscape being viable alternative or synergistic addition to other coating methods.

### BRIEF DESCRIPTION OF THE DRAWINGS

Embodiments are illustrated by way of example, and not by way of limitation, in the figures of the accompanying drawings in which like reference numerals refer to similar elements and in which:

FIG. 1 schematically illustrates an example electrostatic deposition process.

FIG. 2 schematically illustrates an example electrostatic deposition process as disclosed herein.

FIG. 3 schematically illustrates the electrostatic deposition process of FIG. 2 as viewed along line A-A of FIG. 2

FIG. 4 schematically illustrates an alternate example of an electrostatic deposition process.

FIG. 5A schematically illustrates an alternate example of an electrostatic deposition process.

FIG. 5B schematically illustrates another alternate example of an electrostatic deposition process.

FIG. 6 is a chart showing example results of various coating processes.

FIG. 7A is a chart showing deposition efficiencies without individual modifications.

FIG. 7B illustrates an example embodiment of a bare microneedle array.

FIG. 7C illustrates an example embodiment of an unmasked trehalose-sprayed microneedle array.

FIG. 7D illustrates an example embodiment of a trehalose-sprayed microneedle array without insulation on the focus ring or on the buried extractor target.

FIG. 7E illustrates an example embodiment of a trehalose-sprayed microneedle array with all enhancements.

FIG. 7F illustrates an example embodiment of a trehalose-sprayed silicon chip.

FIG. 7G illustrates an example embodiment of a trehalose-sprayed microelectrode pattern.

FIG. 7H is a chart showing example deposition efficiencies for different base materials.

FIG. 8A and FIG. 8B illustrate an example embodiment of a self-limiting electrospray deposition (SLED) process.

FIGS. 9A and 9B are charts showing process results of self-limiting electrospray deposition (SLED) process with DNA alone and DNA with Trehalose added.

FIG. 10A is a chart showing process results of various electrospray deposition processes.

FIG. 10B shows an example embodiment of a microneedle array without a silicone mask of the type used for the chart in FIG. 10A.

FIG. 10C shows an example embodiment of a microneedle array with a silicone mask of the type used for the chart in FIG. 10A.

FIG. 11A to FIG. 11C show an example embodiment of selective electrospray deposition (SLED) onto a three-dimensional object.

FIG. 12A to FIG. 12C show an alternate example embodiment of selective electrospray deposition (SLED) onto a three-dimensional object.

FIG. 13 is a chart showing process results of selective electrospray deposition (SLED).

FIG. 14A illustrates selective electrospray deposition (SLED) on a small target.

FIG. 14B is a chart showing dewetting width and spray height.

FIG. 15A to FIG. 15D compare microneedle arrays coated with various coating technologies.

FIG. 16A is an example embodiment of a microneedle array subject to various coating techniques with various ingredients.

FIG. 16B and FIG. 16C are charts showing process results of the coatings on the microneedle array of FIG. 16A.

FIG. 17A illustrates a DNA delivery using electrospray deposition.

FIGS. 17B and 17C illustrate results of the DNA delivery of FIG. 17A.

FIG. 18A and FIG. 18B illustrate results of the DNA delivery applied via self-limiting electrospray deposition (SLED).

FIG. 19 is a chart of wavelength versus absorbance related to the determination of ultraviolet visibility.

FIG. 20 shows a calibration curve of 0.0025 wt % rhodamine B in water in a chart of an amount of rhodamine versus an integrated area of rhodamine peak related to the determination of ultraviolet visibility.

FIG. 21A and FIG. 21B show high-performance liquid chromatography results for a sample reference and a GLS-1027 sample on respective charts of retention time versus height.

FIG. 22 is a block diagram that illustrates a computer system 1300 upon which an embodiment of the invention may be implemented.

FIG. 23 illustrates a chip set 1400 upon which an embodiment of the invention may be implemented.

### DETAILED DESCRIPTION

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Notwithstanding that the numerical ranges and parameters setting forth the broad scope are approximations, the numerical values set forth in specific non-limiting examples are reported as precisely as possible. Any numerical value, however, inherently contains certain errors necessarily resulting from the standard deviation found in their respective testing measurements at the time of this writing. Furthermore, unless otherwise clear from the context, a numerical value presented herein has an implied precision given by the least significant digit. Thus a value 1.1 implies a value from 1.05 to 1.15. The term “about” is used to indicate a broader range centered on the given value, and unless otherwise clear from the context implies a broader range around the least significant digit, such as “about 1.1” implies a range from 1.0 to 1.2. If the least significant digit is unclear, then the term “about” implies a factor of two, e.g., “about X” implies a value in the range from 0.5× to 2×, for example, about 100 implies a value in a range from 50 to 200. Moreover, all ranges disclosed herein are to be understood to encompass any and all sub-ranges subsumed therein. For example, a range of “less than 10” for a positive only parameter can include any and all sub-ranges between (and including) the minimum value of zero and the maximum value of 10, that is, any and all sub-ranges having a minimum value of equal to or greater than zero and a maximum value of equal to or less than 10, e.g., 1 to 4.

As used herein, the term “additive manufacturing” refers to the industry standard term (ASTM F2792). It is usually defined as the process of joining materials to make objects from 3D model data, usually layer upon layer, as opposed to subtractive manufacturing methodologies. 3D printing is a type of additive manufacturing. The term “3D printing” is also used widely to refer to various additive manufacturing methods, so the term “3D printing” has some generality too.

One of the longest-standing engineering challenges is the problem of wasted material mass. One example is in the field of coatings, where for many applications, including protective (e.g. anti-fouling, anti-corrosion, anti-static, and ultra-violet (UV) barrier) and active (e.g. catalytic and sensing) coatings, only the thin, top-most layer is necessary for the functionality. This can be especially problematic when high-efficiency nanomaterials or other advanced materials are employed in the coatings, resulting in significant unused materials cost.

Electrospray deposition (ESD) is one of a family of electrostatically-driven materials deposition processes wherein a high voltage electric field (typically >100 kilovolts per meter, kV/m) is used to create fluid droplets or extruded wires. ESD describes conditions where dilute (typically <5 vol %) spray solutions are placed under an electric field while being emitted through a narrow capillary. The field creates charge on the surface of the fluid that in turn draws the fluid into a Taylor cone which emits droplets. These charged droplets split into a size where surface and electrostatic forces are balanced in one or several generations of droplets of narrow dispersion. As each of these droplets arrive at a grounded or opposite polarity target, it delivers the material contained within, depositing a coating of material.

Electrospray deposition processes are disclosed in the following references. U.S. Provisional Patent Application No. 62/683,869, filed Jun. 12, 2018, titled THICKNESS-LIMITED ELECTROSPRAY DEPOSITION OF THERMORESPONSIVE MATERIALS, is incorporated by reference herein in its entirety. U.S. Non-Provisional patent application Ser. No. 17/251,262, filed Dec. 11, 2020, titled THICKNESS-LIMITED ELECTROSPRAY DEPOSITION, is incorporated by reference herein in its entirety. U.S. Provisional Patent Application No. 62/848,320, filed May 15, 2019, titled METHODS AND DEVICES FOR THICKNESS-LIMITED ELECTROSPRAY ADDITIVE MANUFACTURING, is incorporated by reference herein in its entirety. U.S. Non-Provisional patent application Ser. No. 17/595,341, filed Nov. 15, 2019, titled METHODS AND DEVICES FOR THICKNESS-LIMITED ELECTROSPRAY ADDITIVE MANUFACTURING, is incorporated by reference herein in its entirety.

The present Inventors have devised a unique and innovative approach to electrospray deposition. Specifically, the Inventors dispose the target of the electrospray deposition process on a buried extractor target. The buried extractor target includes a conductive body and a layer of insulation between the target and the conductive body. The buried extractor target shapes the charge landscape and focuses the spray onto the intended target. Deposition efficiency using the buried target extractor is observed experimentally to approach 100%.

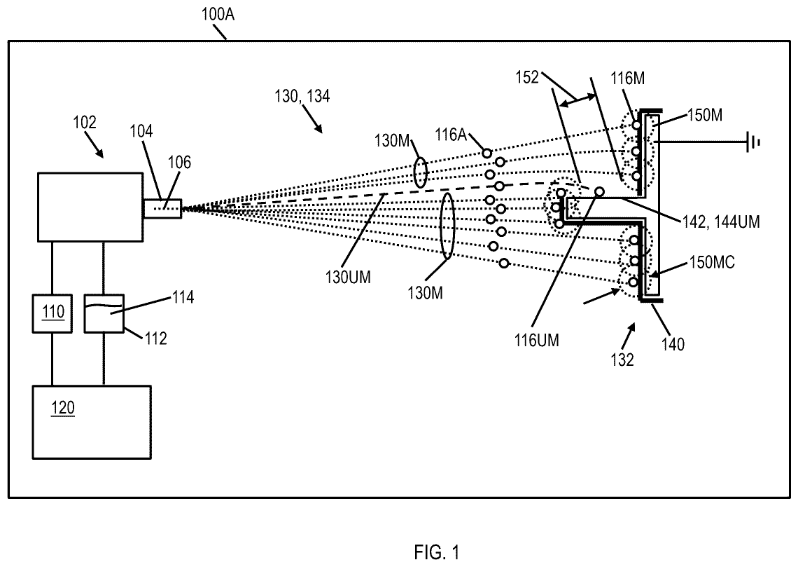

FIG. 1 schematically illustrates an example electrospray deposition process. The figures presented and discussed are very highly conceptualized representations of the electrostatic deposition process and the generalization is not meant to be limiting. In addition, while the disclosure provided herein attempts to explain the mechanisms at work, the invention is not bounded by these explanations nor by these mechanisms. Neither is the Invention limited to these mechanisms.

An electrospray mechanism 100A includes a spray apparatus 102 having an emitter 104. The emitter 104 includes a capillary 106 through which a medium flows and from which the medium is emitted. A high voltage power source 110 is in electrical communication with the spray apparatus 102 and is configured to apply high voltage to the medium exiting the emitter 104. A medium source 112 is configured to supply the medium 114 to the spray apparatus 102. A controller 120 is in electrical and signal communication with the high voltage power source 110, the medium source 112, and the spray apparatus 102 to properly control the electrospray deposition process.

In the electrospray deposition process, the high voltage power source 110 applies a high voltage to at least the emitter 104 and the medium 114 therein. This high voltage establishes an electric field 130 between the emitter 104 and a target 132, which is held at a lower voltage or is grounded. The target 132 is typically composed of a conductive material. This high voltage also disperses the medium 114 exiting the emitter 104 into a spray plume composed of droplets of the medium of various sizes that is directed toward the target 132. The droplets of the medium 114 include solvent and payload materials 116A, dispersed or dissolved therein. As the droplets traverse the distance to the target 132, the solvent may fully evaporate leaving airborne payload materials 116A that tend to follow field lines 134 established by the electric field 130 enroute to the target 132. Solvent may also reach the target 132 and continue to evaporate.

Upon initiation of the electrospray deposition process and the electric field 130, the spray plume directs payload materials onto the mask 140 as payload materials 116M and onto the unmasked portion 142 as payload materials 116UM in what might be likened to an overspray that occurs prior to establishing a stable electric field 130 and stable spray plume. The overspray may fully surround the target 132. The payload materials 116M on the mask 140 remain charged because they are within the electric field 130 and field lines 130M are established with the payload materials 116M. This is possible because the charged payload materials 116M in turn establish field lines with the target 132 through the mask 140. Field lines 130UM are also established to the unmasked portion 142 due to the payload materials 116UM and exposed conductive surface 144UM of the unmasked portion.

A charge 150M forms around the payload materials 116M on the mask 140 and is characterized by a charge strength 150MC. The strength of the charge 150MC is relatively large because the relatively small profile of the target 132 within the electric field 130. In other words, the entire electric field 130 is focused on a relatively small target 132. The resulting relatively large strength of the charge 150MC crowd the unmasked portion 142 and this results in a relatively small window 152 that can be “seen” by the payload materials 116A. The field line(s) 130UM to the unmasked portion 142 are thereby not necessarily appreciably more dense than the field lines 130M to the mask 140. The payload materials 116A are thereby not strongly drawn to the field line(s) 130UM over the field lines 130M to the mask 140. As a result, the payload materials 116A continue to be deposited on the mask 140 as well as the unmasked portion 142, which represents a lower deposition efficiency that is sought.

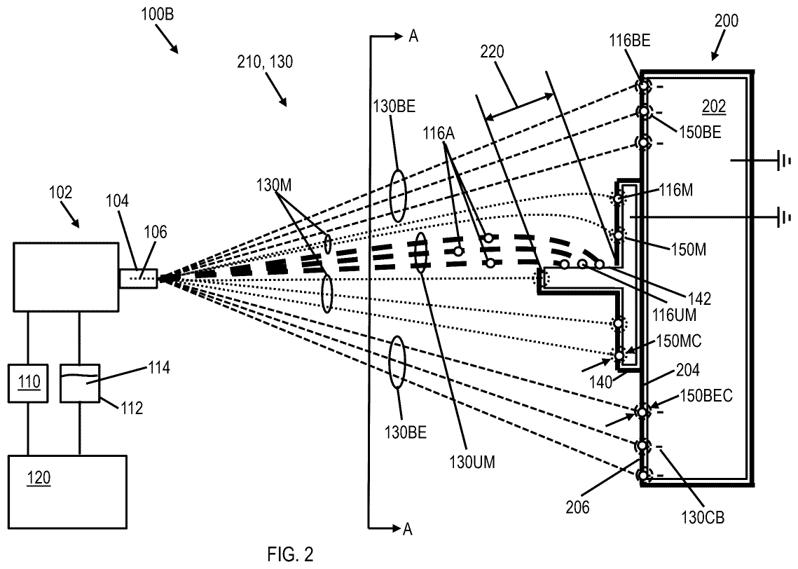

FIG. 2 schematically illustrates an example electrospray deposition process as disclosed herein. The process disclosed in the example of FIG. 2 includes an electrospray mechanism 100B with the same hardware, plus a buried extractor target 200. The buried extractor target 200 includes a conductive body 202 that is composed at least in part of a conductive material. The conductive body 202 is held at a lower voltage/potential than the relative high voltage of the emitter 104 or is grounded. The extractor target further includes insulation 204 disposed at least between the conductive body 202 and the target 132. The target 132 is disposed on a support face 206 of the buried extractor target 200 and the electrospray deposition process is initiated.

Like the process of FIG. 1, upon initiation of the electrospray deposition process and an electric field 210, the spray plume directs payload materials onto the mask 140 as payload materials 116M and onto the unmasked portion 142 as payload materials 116UM prior to establishing a stable electric field 130 and stable spray plume. In addition, the spray plume directs payload materials onto the insulation 204 of the buried extractor target 200 (a.k.a. insulated conductive body) as payload materials 116BE. The payload materials 116M on the mask 140 and the payload materials 116BE on the buried extractor target 200 remain charged because they are within the electric field 210. Here again, field lines 130M are established with the payload materials 116M and field lines 130UM are established to the unmasked portion 142. In addition, field lines 130BE are established with payload materials 116BE because they are within the reshaped/landscaped electric field 210. This is possible because the charged payload materials 116BE in turn establish field lines 130CB with the conductive body 202 through the insulation 204.

The resulting landscaped electric field 210 is larger than the electric field 130 of the process of FIG. 1 and spread out among more payload materials 116. Charges 150MC, 150BEC are formed around the payload materials 150M and 150BE respectively. Since there are more payload materials 116M, and 116BE in this process compared to the process of FIG. 1, the electric field 210 is spread out among more payload materials 116M, 116BE. The resulting charges 150MC, 150BEC around the payload materials will be relatively small compared to the charges in the process of FIG. 1.

The smaller charges 150MC, 150BEC do not crowd the window 220 of the unmasked portion 142 to the same extent. The resulting field lines 130UM can thereby better “see” the unmasked portion 142 better. As a result, the resulting field lines 130UM are characterized by a greater strength than the other field lines 130BE, 130M (as indicated by their relatively thicker lines). The payload materials 116A in the spray plume are drawn to the relatively denser field lines 130UM more so than they are drawn to the other field lines 130BE, 130M. Consequently, the payload materials 116A are more likely to follow the field lines 130UM to the unmasked portion 142 than to follow the other field lines elsewhere (as indicated by payload materials 116A only being in field lines 130UM).

The buried extractor target 200 thereby landscapes the electric field 210 by spreading out the field lines and by reducing a magnitude and associated interference of charges 150 of oversprayed payload materials (on the mask 140 and on the buried extractor target 200). This enables the field lines 130UM that are associated with the unmasked portion 142, which is the desired destination of the payload materials 116A, to be relatively strong and thereby attract more of the payload materials 116A. This increases deposit efficiency. In addition, architecting the electric field 210 in this way stabilizes the electric field which, in turn, stabilizes the spray plume, field lines, and payload materials 116A therein.

The magnitude of the charges 150MC and 150BEC can be tailored by tailoring the insulation value of the mask 140 and the insulation value of the insulation 204 individually and relative to each other. For example, the magnitude of charge 150MC can be reduced relative to the magnitude of charge strength 150BEC. This may result in the field lines 130M being relatively less dense than the field lines 130BE. Reducing the density of the field lines 130M may provide a buffer of relatively less dense field lines 130M around the field lines 130UM. The buffer may help contain the payload materials 116A in the preferred field lines 130UM by making it harder for the payload materials 116A to reach/jump to adjacent field lines such as 130BE. Insulating materials here may be characterized as having bulk resistivity greater than about 1 GΩ/m and not possessing other means of charge dissipation, such as mass transport or surface conductivity and are at a thickness sufficient to prevent the dissipation of charge, for example greater than about 10 μm.

### Example Embodiments

The disclosure below applies to the examples provided below and not necessarily to the entire disclosure herein.

In an example embodiment, the target 132 and/or the buried extractor target 200 may be subject to temperature control. Heating or cooling the target 132 and/or the buried extractor target 200 may alter a viscosity of liquid materials that arrive thereon. This may, in turn, ensure the liquid materials don't electrowet away. Alternately, one of the target 132 and/or the buried extractor target 200 may be heated and the other cooled to achieve desired electrowetting affects.

In an example embodiment, the masking procedure may be an additive masking procedure (e.g., adding insulating regions to a conductive target). Alternately, the masking procedure may be a subtractive masking procedure (e.g., adding conductive regions to an insulating target).

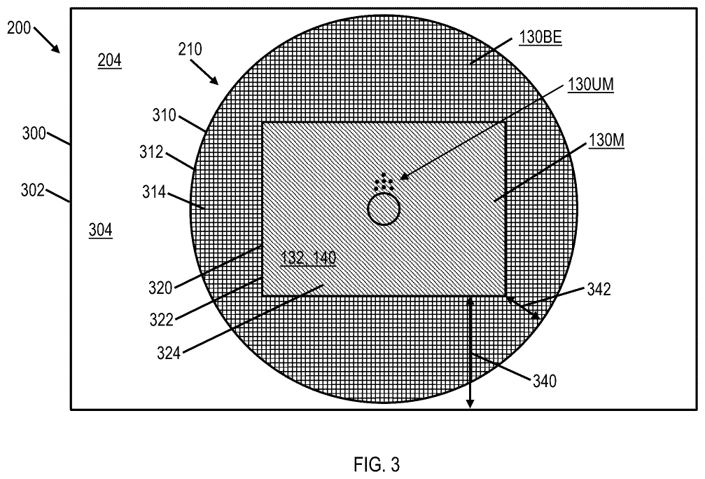

FIG. 3 schematically illustrates the electrostatic deposition process of FIG. 2 as viewed along line A-A of FIG. 2. FIG. 3 is seen from the viewpoint of the emitter 104. The electric field 210 is shown as being conical, but any suitable shape can be landscaped. Field lines 130BE to the buried extractor target 200 and field lines 130M to the mask 140 are shown. In addition, field lines 130UM are shown leading to the unmasked portion 142.

The buried extractor target 200 establishes an extractor target profile 300 as seen by the emitter 104. A perimeter 302 of the extractor target profile 300 establishes an extractor target profile area 304. The electric field 210 establishes an electric field profile 310 as seen by the emitter 104. A perimeter 312 of the electric field profile 310 establishes an electric field profile area 314. The target 132 establishes a target profile 330 as seen by the emitter 104. A perimeter 322 of the target profile 330 establishes a target profile area 324.

In an example, the target 132 is disposed fully within the perimeter 302 of the extractor target profile 300. In an example, the target 132 is disposed fully within perimeter 312 of the electric field profile 310 such that field lines 130BE fully surround the target 132. In an example, the extractor target profile area 304 is at least 500% larger than the target profile area 324. In an example, the extractor target profile area 304 is at least 100 times the target profile area 324. In an example, electric field profile area 314 is at least 1000% larger than the target profile area 324. Although the electric field profile area 314 is depicted as being smaller than the extractor target profile 300, this is not necessary. The electric field profile area 314 may be larger than the extractor target profile 300.

In an example embodiment, the perimeter 322 of the target profile 330 maintains a setback 340 of at least 2 cm from all points of the perimeter 312 of the unaltered electric field profile 310. In an example, the perimeter 322 of the target profile 330 maintains a setback 342 of at least 1 cm from all points of the perimeter 302 of the extractor target profile 300.

In an example, a mass of the buried extractor target 200 is at least 1,000 times a mass of the target 132. In an example, a mass of the buried extractor target 200 is at least 1,000,000 times a mass of the target 132.

Although the process has been described with the presence of a mask 140 on the target 132, a mask need not to be present. The principles related to the buried extractor target 200 would still apply.

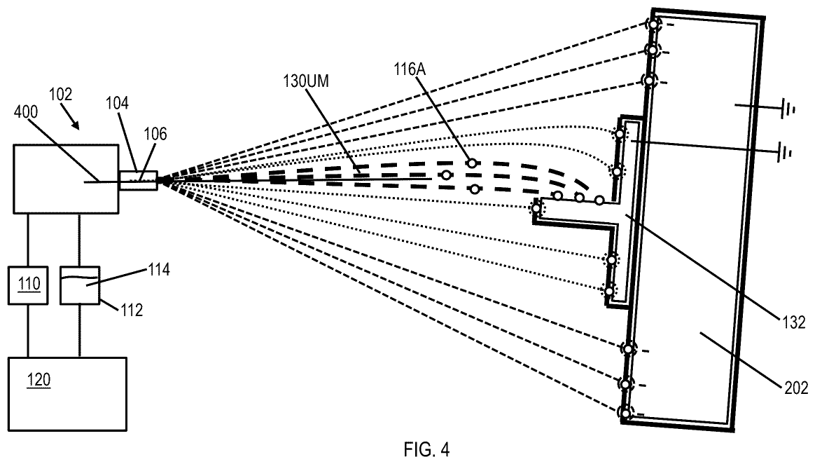

FIG. 4 schematically illustrates an alternate example of an electrostatic deposition process. In this example, the target 132 and the buried extractor target 200 are repositioned relative to the emitter 104 to more closely align an axis 400 of the capillary 106 with the trajectory of the field lines 130UM which are preferred to carry the payload materials 116A. This alignment starts the payload materials 116A traveling along a path the coincides with the field lines 130UM, which increases the likelihood the payload materials 116 will follow field lines 130UM.

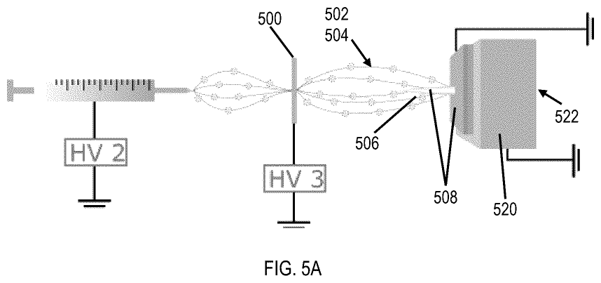

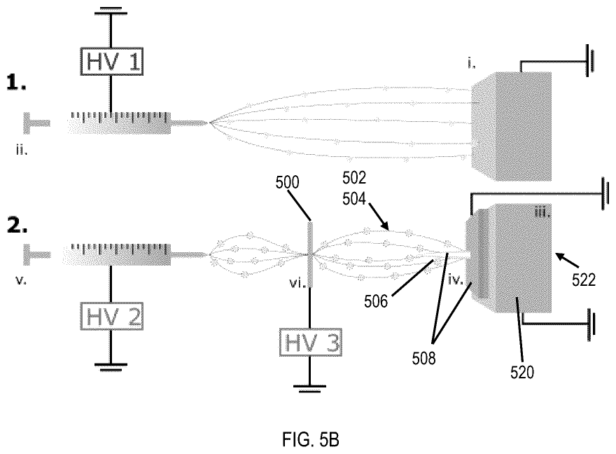

FIG. 5A schematically illustrates an alternate example of an electrospray deposition process. In this example, a focusing ring 500 composed of an insulating or conductive material held at a voltage from about 0 to 75% of the driving voltage is used to focus the field lines 502 and associated shape of the spray 504 of medium passing therethrough enroute to the unmasked area 506 of the target 508. The target 508 is disposed on the insulation 520 of the buried extractor target 522.

FIG. 5B schematically illustrates an alternate example of an electrospray deposition process. (1) indicates, for example, a negative polarity ethanol prespray. (2) indicates, for example, a positive polarity spray of the target 508.

In an alternate embodiment, an additional potential difference may be created. For example, the focusing ring 500 and the spray 504 may have a positive potential, the buried extractor target 522 may be grounded, and the target 508 may have a negative potential. In various embodiments, the emitter 104, the focus ring 500, the target 508, and the buried extractor target 522 may be held at any combination of different potentials relative to each other to manipulate the charge landscape to achieve different desired depositions. Each potential may be unique, or one or more may be the same while others are unique. In an embodiment the voltages may decrease such that a voltage of the emitter 104 may be greater than a voltage of the focus ring 500, which may be greater than a voltage of the target 508, which may be greater than a voltage of the buried extractor target 522. In another embodiment, a voltage of the target 508 may be lower than a voltage of the buried extractor target 522, which is lower than a voltage of the focus ring 500, which is less than a voltage of the emitter 104. These examples are non-limiting, and any order or polarity may be used.

As used herein, a relatively high voltage may describe, in a non-limiting example, a first positive voltage that is higher than a second positive voltage or a second negative voltage. However, the disclosure is not so limited. Potential difference that creates a polarity between components is more broadly applicable. In a first polarity scheme, for example, the nozzle may be at a first positive voltage and the target may be at a second voltage that is positive but lower than the first positive voltage. In a different first polarity scheme, the nozzle may be at a first positive voltage and the target may be at second voltage that is negative. In another first polarity scheme, the nozzle may be at a first negative voltage and the target may be at a second voltage that is more negative than the first negative voltage. Potential differences that result in the first polarity scheme are not limited to the above examples and other potential differences that create the first polarity may be used.

In a second polarity scheme, for example, the nozzle may be at a first positive voltage and the target may be at a second voltage that is positive but higher than the first positive voltage. In a different first polarity scheme, the nozzle may be at a first negative voltage and the target may be at second voltage that is positive. In another first polarity scheme, the nozzle may be at a first negative voltage and the target may be at a second voltage that is less negative than the first negative voltage. Potential differences that result in the second polarity scheme are not limited to the above examples and other potential differences that create the second polarity may be used. Moreover, the schemes described above between the nozzle and the target can be individually applied between any two (or more) of at least the emitter 104, the focus ring 500, the target 508, and the buried extractor target 522 to create any desired potential difference scheme(s) between the two (or more) components.

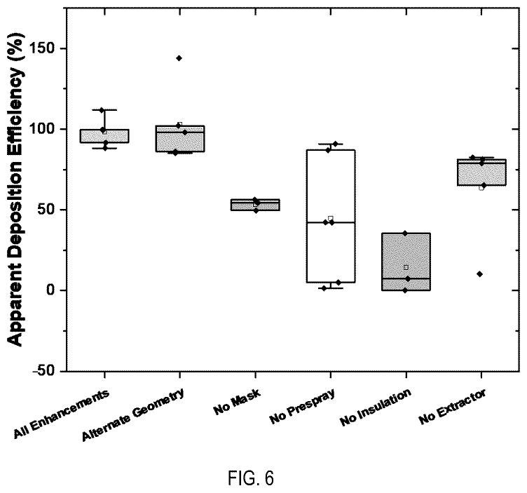

FIG. 6 is a chart showing example results of various coating processes. In a first coating process a needle was used. In a second coating process a flat geometry was used. Results are also shown for processes in which no mask was applied to the target, in which no prespray was performed, in which no insulation was present on the conductive body of the buried extractor target, and in which no extractor target was used. It can be seen that the process disclosed herein, together with the use of a pre-spray, provides deposition efficiency approaching nearly 100%.

### Approaches to Engineer the Charge Landscape

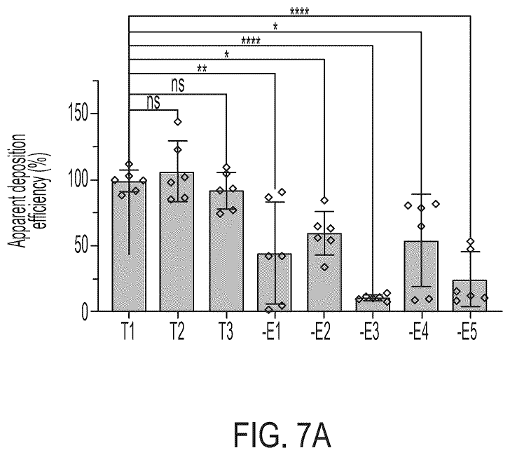

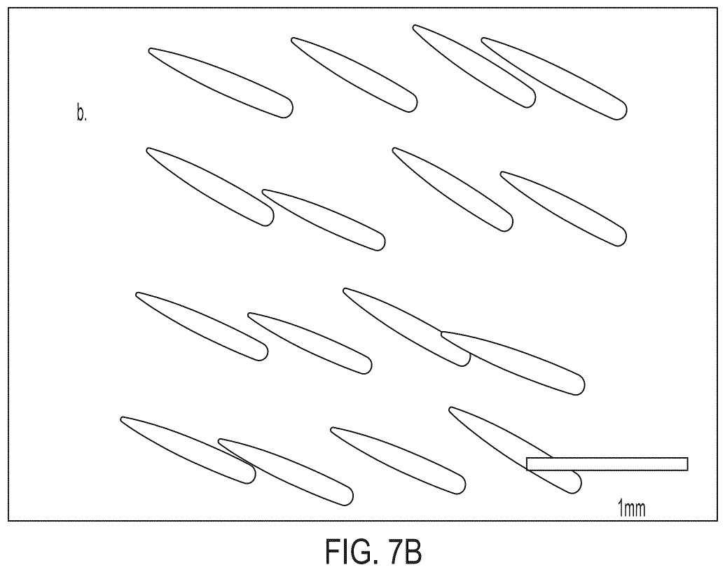

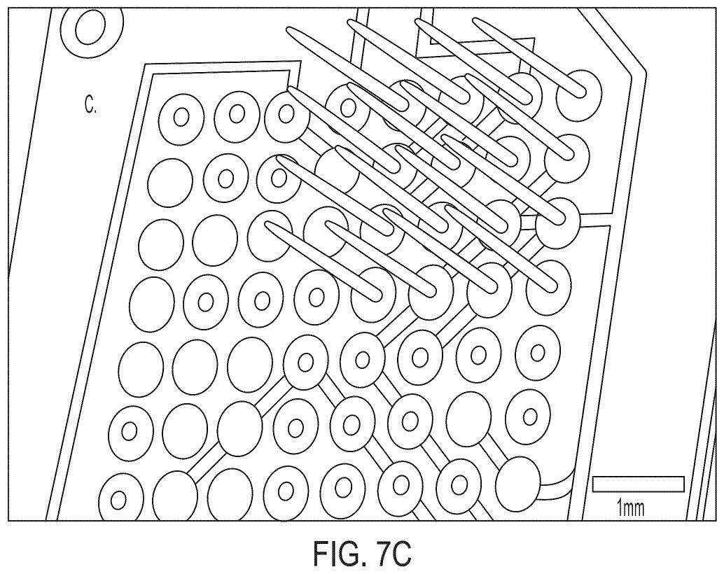

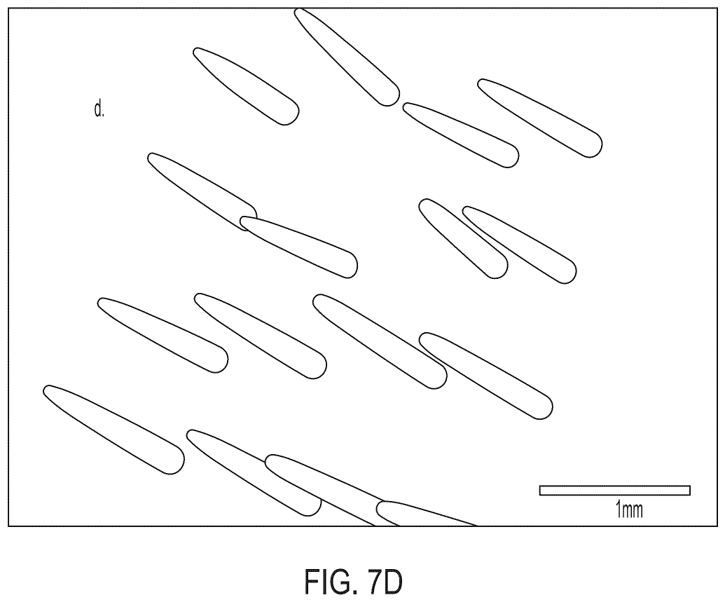

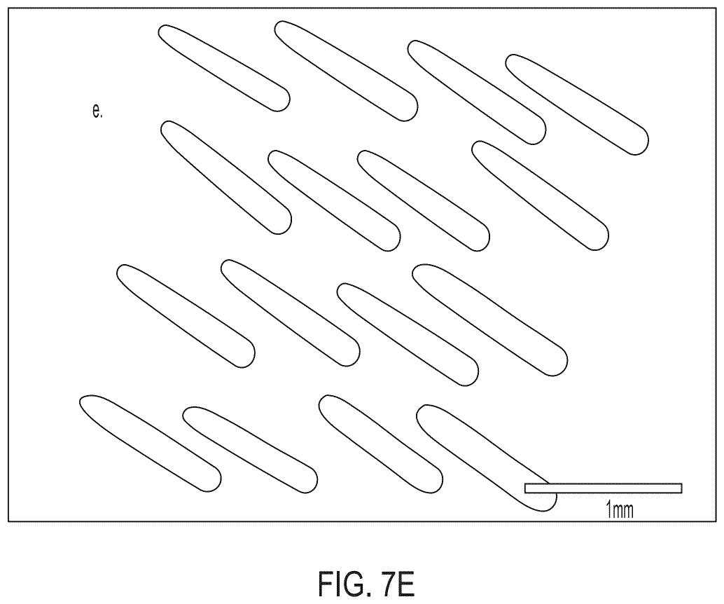

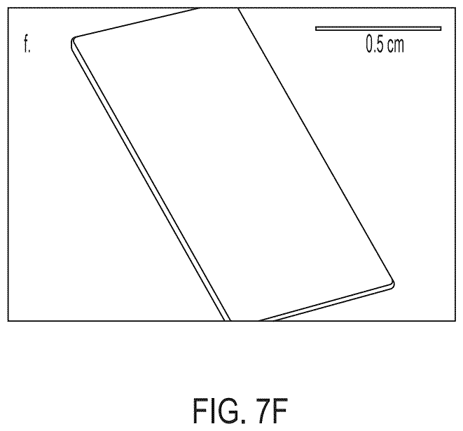

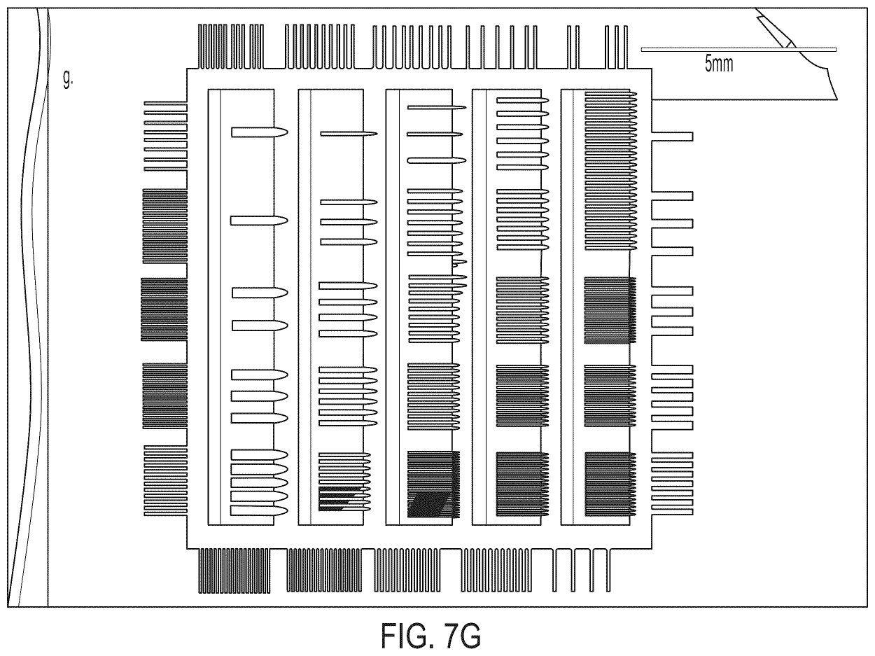

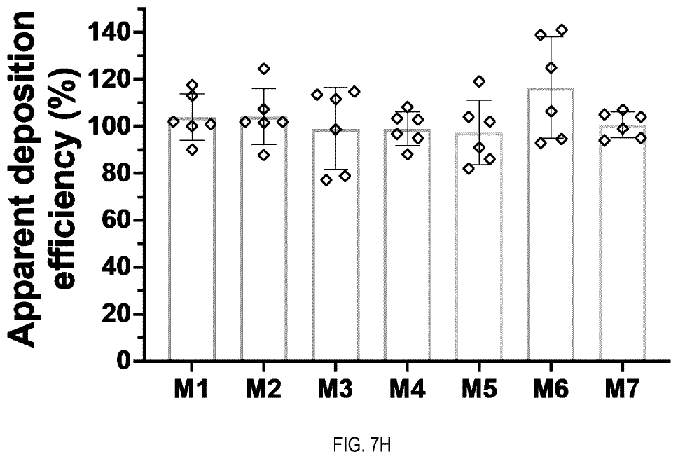

FIG. 7A shows ultraviolet visible (UV-vis) deposition efficiencies with all process enhancements for microneedle array MNA (T1), silicon chip (T2), and microelectrode test pattern printed on borofloat (T3) samples with 0.2 wt % trehalose sprays, as well as MNA samples with a single removed enhancement: no pre-spray (−E1), no buried extractor (−E2), no insulation of focus ring and extractor ground (−E3), no insulating mask (−E4), and no focus ring (−E5).

FIG. 7B illustrates an example embodiment of a bare MNA (no insulating mask). FIG. 7C illustrates an example embodiment of an unmasked trehalose-sprayed MNA. FIG. 7D illustrates an example embodiment of a trehalose-sprayed MNA without insulation on the focus ring or on the buried extractor target. FIG. 7E illustrates an example embodiment of a trehalose-sprayed MNA with all enhancements. FIG. 7F illustrates an example embodiment of a trehalose-sprayed silicon chip for generality. FIG. 7G illustrates an example embodiment of a trehalose-sprayed microelectrode pattern for generality.

It should be noted that some of the apparent efficiencies are greater than 100%, which is hypothesized to be a combined effect of the accuracy of the UV-vis approach, especially for small amounts of material, and the accumulation of some dried material on the tip of the needle between samples and stabilization of the spray. From an ultimate system design standpoint, automated sample motion and spray stabilization, such as recently shown by Toth et al., (#84) would likely improve the precision of the technique. Despite this, there are still significant differences between the enhanced and unenhanced results.

A significant difference is the effect of allowing for alternative targets. This is shown here in two ways. The first is accomplished by removing a silicone mask (FIG. 7C), which allows for 45±35% of the coating to be deposited on unwanted portions of the sample, consistent with the quantity of non-desired conductive surface. The second is to remove the masking tape from the extractor ground and focus ring (FIG. 7D) which provides for a much larger conductive surface for the spray to deposit. The role of this tape is to initially build charge during the first few moments of spray which redirect the field lines towards the unmasked portions of the target. 91±2% of the spray is diverted to these large alternative targets, particularly the focus ring, which does not have a field of its own strong enough to repel the spray and requires a slight build-up of charge. Removal of the focus ring allows droplets to follow a wider range of field paths allowing for spray to escape to other distant grounds or to the circulating air in the spray chamber, leading to a reduction of efficiency of 22±15%. The pre-spray, which establishes the “blank slate” condition, lacking which, the charge in the chamber gradually increases to the point of destabilizing the spray, leading to a gradual reduction in efficiency of 60±46%. Finally, removing the extracting ground (buried extractor target) causes a loss of efficiency of 60±16%, which arises from charge screening and an eventual destabilization of the spray in the absence of the large, stabilizing extracting ground. It is hypothesized that this extracting ground allows the field lines not directed to the target to remain stable against the counter field imposed by the charge deposited on the insulated surfaces.

Implementing all of these process enhancements (FIG. 7E) leads to 104±10% of the spray arriving at the needle tips, indicating that only almost none of the solids payload leaves the needle without arriving at the target. Shifting to a silicon chip (FIG. 7F) or microelectrode test pattern (FIG. 7G) does not change this efficiency (110±25% and 96±18%, respectively).

### Spray Efficiency for Different Materials

FIG. 7H shows UV-vis Deposition efficiencies for different materials, including: Trehalose (T1), GLS-1027 (M2), PEDGA (M3), PVP (M4), PEDOT: PSS (M5), GLS-6150 (M6), and bovine serum albumin protein (M7).

With the exception of PEG, which could not be quantified, all materials have mean apparent efficiencies >97%. It should be addressed that in all cases, only the tracer is being quantified. This is based on an assumption that the composition of the spray remains constant from the syringe to the target. This assumption can be justified by (1) the use of relatively dilute solutions, such that precipitation at the spray needle tip is unlikely, and (2) the fact that the tracer is of commensurate molecular weight to the lightest payload (479 g/mol as compared to 205 g/mol for GLS 1027). This means that, should atomization and diffusive or convective removal of material occur, it would be as likely to occur for the tracer. In the case of PEG, there are two explanations for the low efficiencies, both arising from its low viscosity. First, gravity results in dripping from the needles, which was observed. Second, since the material remains mobile after spray but uncharged due to electrowetting dissipation, (#83), it finds itself at a large potential difference with the spray needle (especially at the sharp needle tip) and can electrospray back to the needle. These inverse polarity droplets can collide with incident spray droplets, dissipating their charge and resulting in undirected droplets that are removed by air flow. This mechanism is less-easily observed and is likely secondary in terrestrial gravity.

### Experimentation

Materials: D-(+)-trehalose dihydrate, PEGDA (Mn=4,000), BSA aqueous solution (20 mg mL-1), HRP Type VI, PEDOT: PSS, rhodamine B, MilliQ water, ethanol, 1-step Ultra TMB-ELISA substrate solution, and Pierce 660 nm protein assay reagent were obtained from Sigma Aldrich. Kollidon 12 (PVP) was obtained from BASF. GLS-6150 (Lot VGX-6150.13A001) and GLS-1027 (Lot 19AK0183A) were obtained from GeneOne Life Science, Inc. Sulfuric acid was obtained from Fisher Scientific. AZ400K developer (potassium-based buffered alkali solution) was obtained from MicroChemicals. PicoPure water was obtained from Hydro Service and Supplies.

Solution Preparation: PEDOT: PSS solutions were prepared by dialyzing dry-redispersable PEDOT: PSS pellets in water over 5 days, ending with a final concentration of 20 mg mL-1. The dialyzed solution is further diluted to 10 mg mL-1. For PEDOT: PSS and BSA, 100 μL of 10 mg mL-1 solutions in water were mixed with 400 μL of pure ethanol and were sprayed onto 1 cm2 silicon chips for ease of re-dispersion. All other solutions were sprayed onto microneedle substrates and prepared by mixing 100 μL of 10 mg mL-1 solutions in water (or 200 proof ethanol in the case of GLS-1027), 10 μL of 25 μg mL-1 rhodamine B, and 450 μL of pure ethanol.

Electrospray Setup: The electrospray setup involves a syringe pump (Harvard Apparatus 11 Plus), one negative high voltage power supply (Acopian Power Supply, N012HA5), two positive high voltage power supplies (Acopian Power Supply, P012HA5), stainless-steel needle (SAI Infusion, 20 gauge, 0.5″), a steel guard ring (4 cm outer diameter, 2 cm inner diameter), 2 mm long stainless-steel microneedles in a 4×4 array, and a humidity and temperature control environmental chamber (ETS). The chamber had a controlled humidity ranging from 15-25% RH and the temperature ranged from 24-27° C. 1 mL Luer Lock syringes with an inner diameter of 4.78 mm were used to load the spray solution. The microneedles were placed on an aluminum holding block where the microneedle array and the holding block were grounded. A positive voltage was applied and adjusted as needed on the syringe needle and the guard ring. A negative pre-spray using 200 proof ethanol was sprayed before each sample. All conductive material within the chamber was insulated through the use of 1 layer of 2 mil Kapton polyimide tape, including the guard ring and the holding block. Microneedle arrays were sonicated in a vial with detergent and water for cleaning.

Experimental Parameters: Sprays were stabilized using the primary voltage with a range of 6-8.5 kV at a constant spray distance of 2 cm to the ring and 4 cm to the target. The ring voltage was held at 0.41 kV. Ambient humidity was regulated to be between 15-25%. All sprays occurred at a flow rate of 0.1 mL/h, corresponding to a mass delivery rate of 180 μg/h of the payload material and 45 ng/h of tracer. Sprays for efficiency calculations were sprayed for 30 min, resulting in 90 μg of material and 45 ng of tracer.

### Apparent Deposition Efficiency Calculation

PEDOT: PSS and BSA samples were dipped into 600 μL of water and measured using the UV-vis and BSA protein A280 function, respectively, of the Thermo Scientific Nanodrop 2000C. Measurements were taken at 260 nm, and no baseline correction was used for the measurements.

For all other samples, needles or chips were dipped into 600 μL of water, or AZ400K developer (MicroChemicals) for GLS-1027, for 2 min until all material is dissolved off the needles. The solution is then analyzed with a Jasco 770 UV-vis spectrophotometer. The results were then background subtracted using a Gaussian fit to extract the rhodamine peak, which was compared to a standard calibration curve generated in the same solvent.

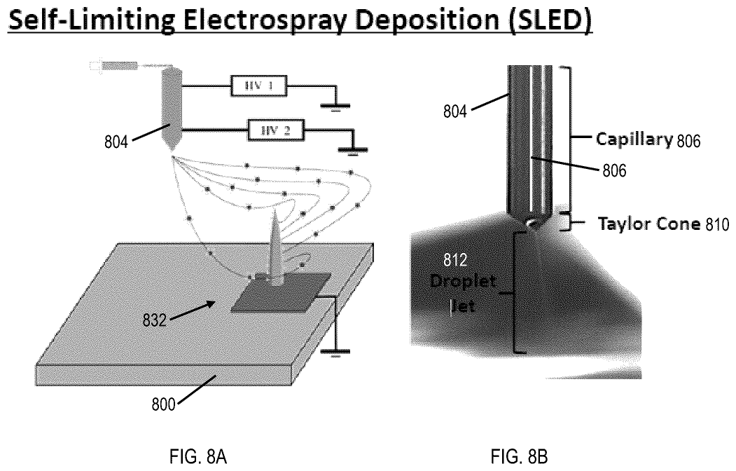

FIG. 8A and FIG. 8B illustrate an example embodiment of a self-limiting electrospray deposition (SLED) process with an ungrounded buried extractor target 800. In this example, the emitter 804 includes a capillary 806 through which the medium flows. The spray cone-jet mode maintains a Taylor cone 810 at the tip of the emitter 804. A droplet jet 812 then flows from the Taylor cone 810 toward the target 832.

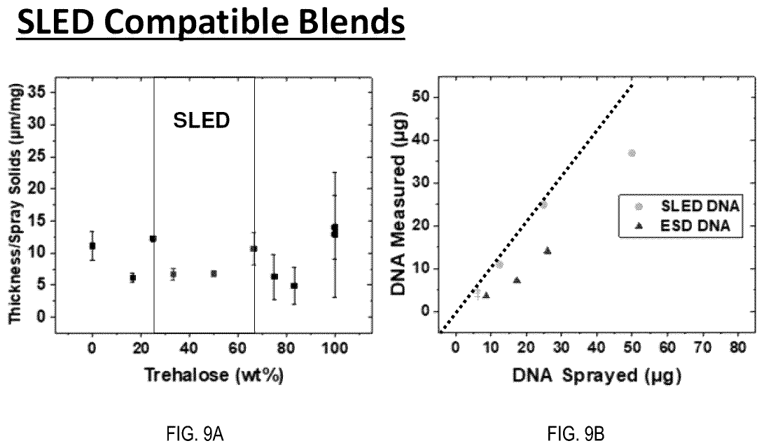

FIGS. 9A and 9B are charts showing process results of self-limiting electrospray deposition (SLED) process with DNA alone and DNA with Trehalose added. DNA in solution with water alone is not necessarily SLED-compatible as DNA is above its glass transition temperature at room temperature. Trehalose was added to the DNA solution to form glassy complexes, and thereby able to exhibit SLED.

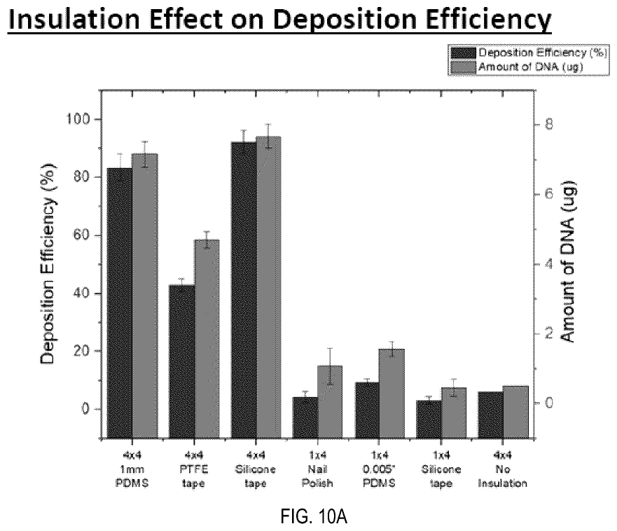

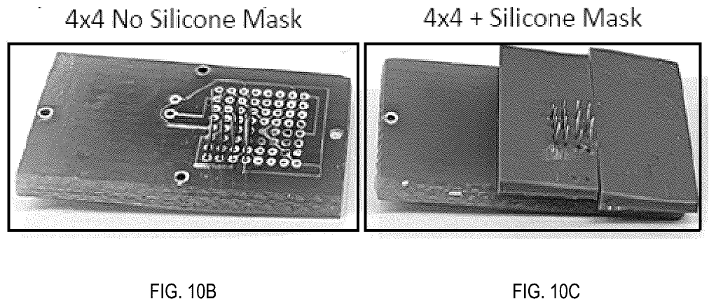

FIG. 10A is a chart showing process results of various electrospray deposition processes. FIG. 10B shows an example embodiment of a microneedle array without a silicone mask of the type used for the chart in FIG. 10A. FIG. 10C shows an example embodiment of a microneedle array with a silicone mask of the type used for the chart in FIG. 10A. Without a form of insulation, the charged spray deposits onto the electrodes with a deposition efficiency of about 6%. Shaping the charge landscape and adding target area directs the spray to the needle tips. Silicone tape with a larger needle array exhibits the highest deposition efficiency.

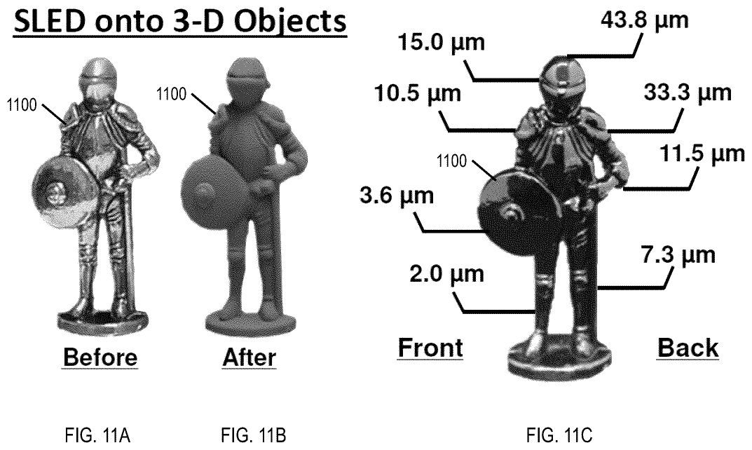

FIG. 11A to FIG. 11C show an example embodiment of selective electrospray deposition (SLED) onto a three-dimensional object 1100. The charge buildup of the material depositing onto the target begins to repel itself, leading to an eventual thickness limit and slowed deposition rate. Because of this characteristic, SLED redirects the spray onto regions of the target that are uncoated, achieving uniform coating.

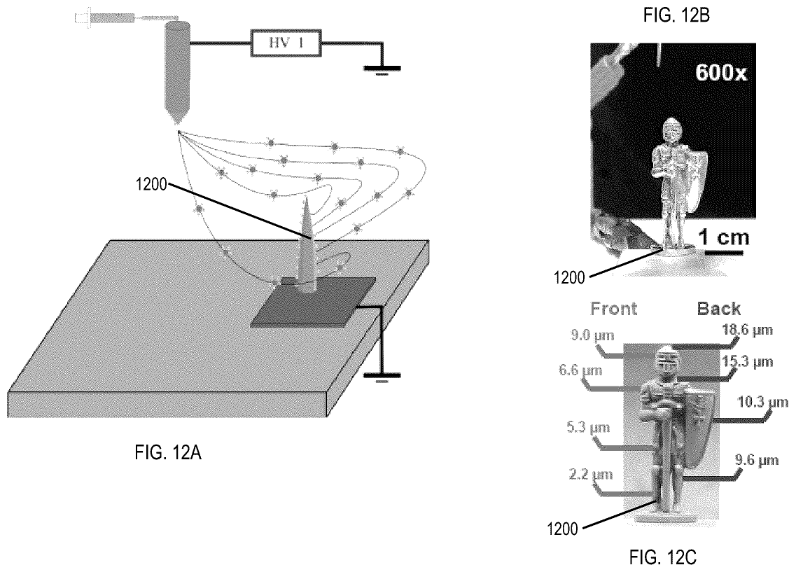

FIG. 12A to FIG. 12C show an example embodiment of selective electrospray deposition (SLED) onto a three-dimensional object. Similar to that of FIG. 11A to FIG. 11C, charge buildup of the material depositing onto the target begins to repel itself, leading to an eventual thickness limit and slowed deposition rate. Because of this characteristic, SLED redirects the spray onto regions of the target that are uncoated, achieving uniform coating. (#44).

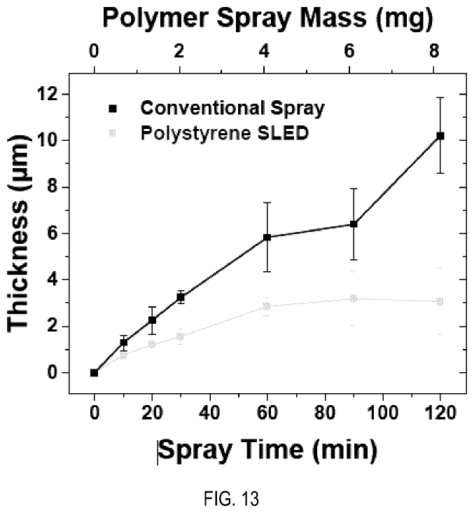

FIG. 13 is a chart showing process results of selective electrospray deposition (SLED) compared to a conventional electrospray deposition process (ESD). (#44).

FIG. 14A illustrates selective electrospray deposition (SLED) on a small target. FIG. 14B is a chart showing dewetting width and spray height. (#91).

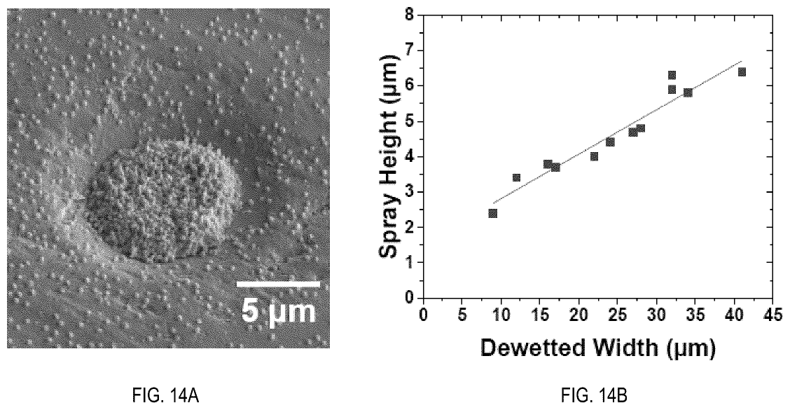

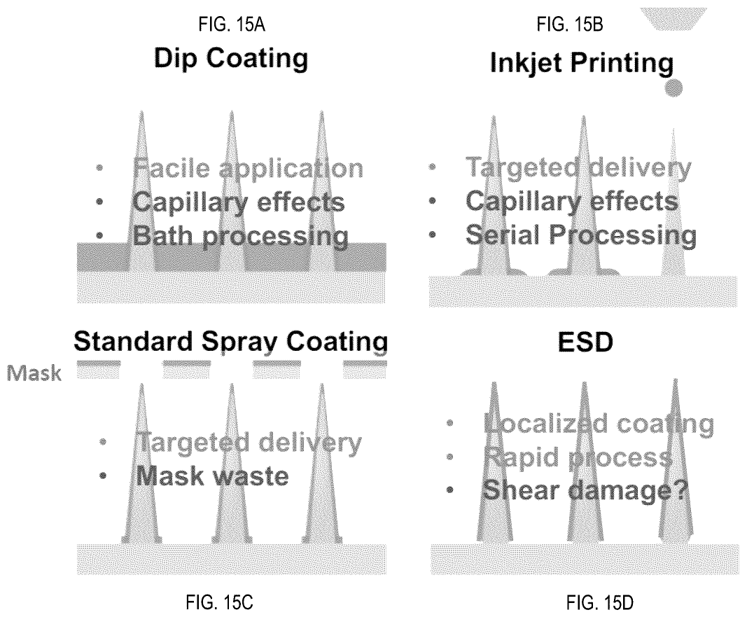

FIG. 15A to FIG. 15D compare microneedle arrays coated with various coating technologies. As can be seen in FIG. 15A, dip coating provides facile application, but exhibits capillary effects and requires bath processing. As can be seen in FIG. 15B, inkjet printing provides targeted delivery, but exhibits capillary effects and requires serial processing. As can be seen in FIG. 15C, standard spray coating provides targeted delivery, but wastes mask material. As can be seen in FIG. 15D, electrospray deposition provides localize coating in a rapid process, but may exhibit shear damage. (#116).

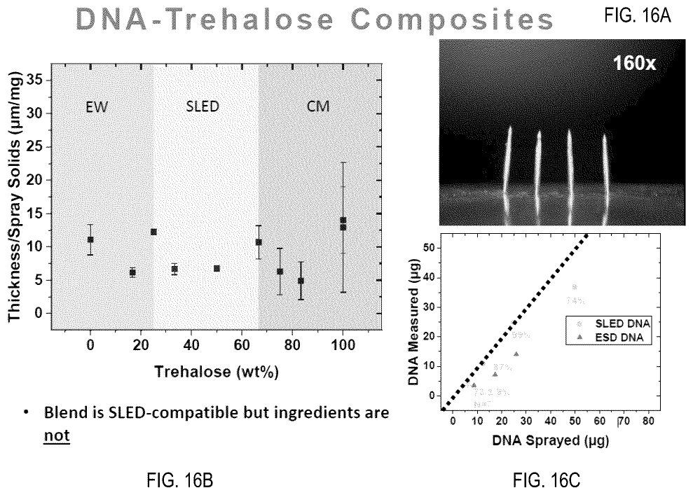

FIG. 16A is an example embodiment of a microneedle array subject to various coating techniques with various ingredients. FIG. 16B and FIG. 16C are charts showing process results of the coatings on the microneedle array of FIG. 16A.

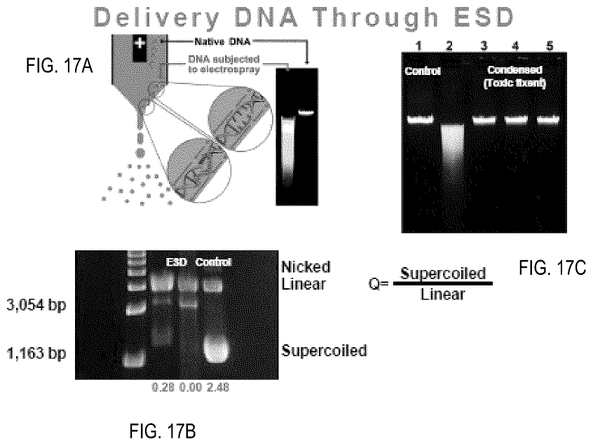

FIG. 17A illustrates a DNA delivery using electrospray deposition. (#92). FIGS. 17B and 17C illustrate results of the DNA delivery of FIG. 17A. (#117).

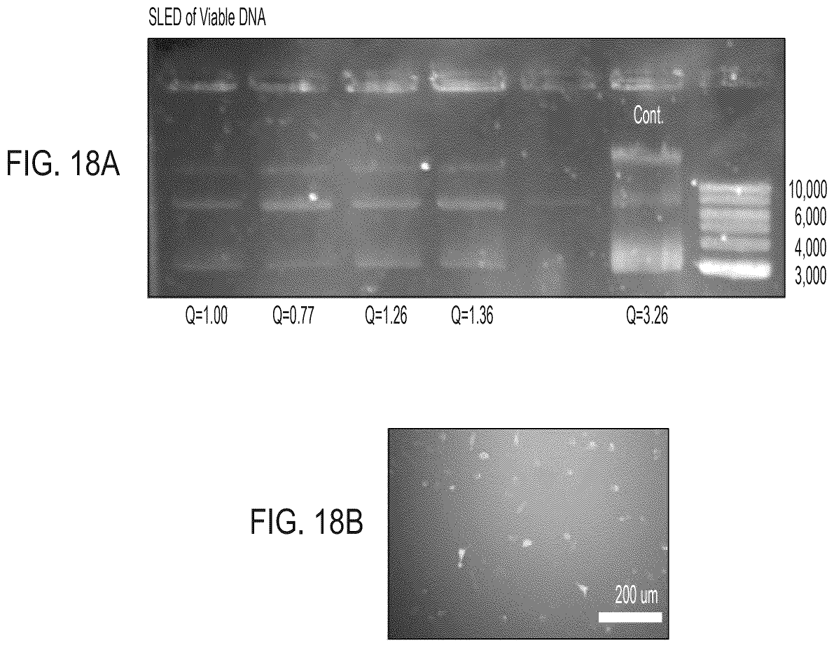

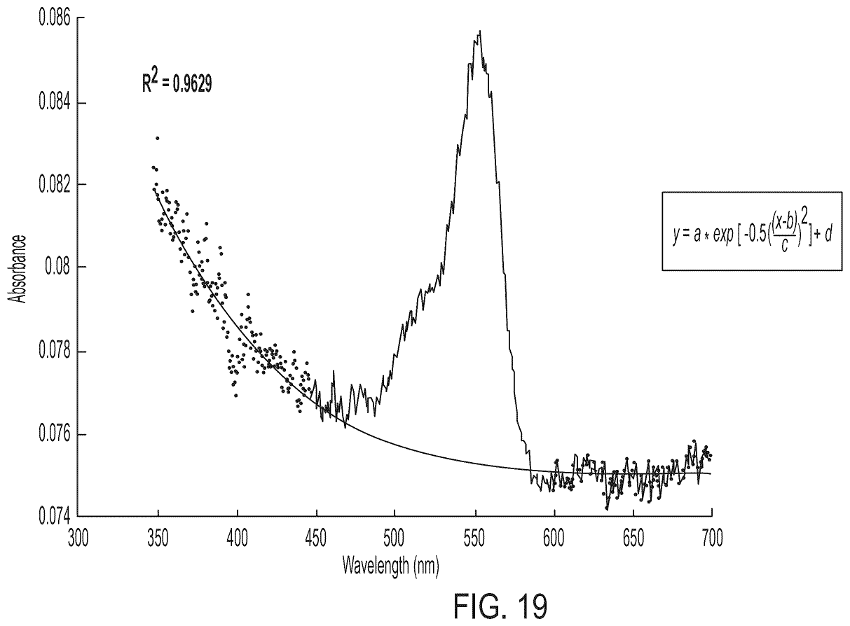

FIG. 18A and FIG. 18B illustrate results of the DNA delivery applied via self-limiting electrospray deposition (SLED). This demonstrates delivery of viable supercoiled pDNA by SLED of up to 70% loading in biocompatible, dissolvable coatings with Q approaching the control. (Q=(Supercoiled/Linear)). GFP DNA from sprayed coating successfully expressed in in vitro electroporation experiments.

FIG. 19 is a chart of wavelength versus absorbance related to the determination of ultraviolet visibility disclosed herein. Rhodamine B is used as an internal standard for UV-vis signal. The Gaussian model is used for background subtraction.

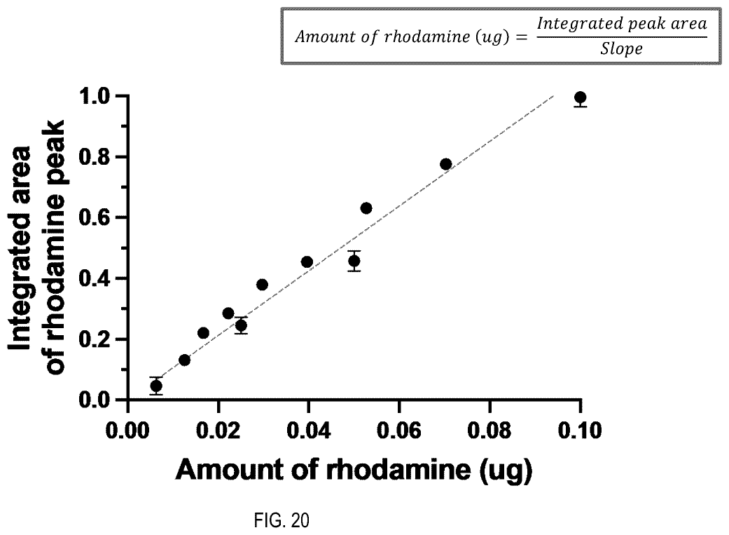

FIG. 20 shows a calibration curve of 0.0025 wt % rhodamine B in water in a chart of an amount of Rhodamine versus an integrated area of rhodamine peak related to the determination of ultraviolet visibility.

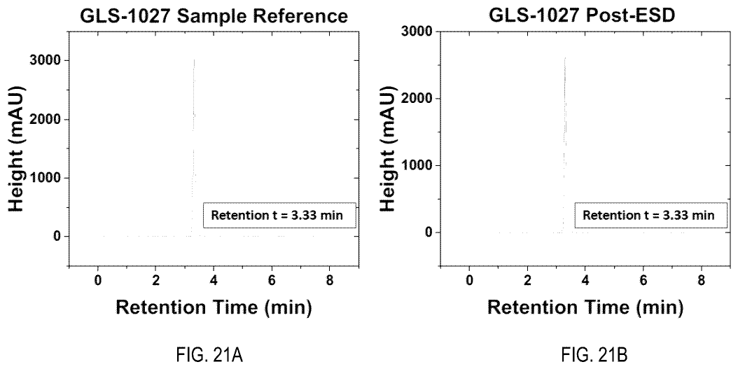

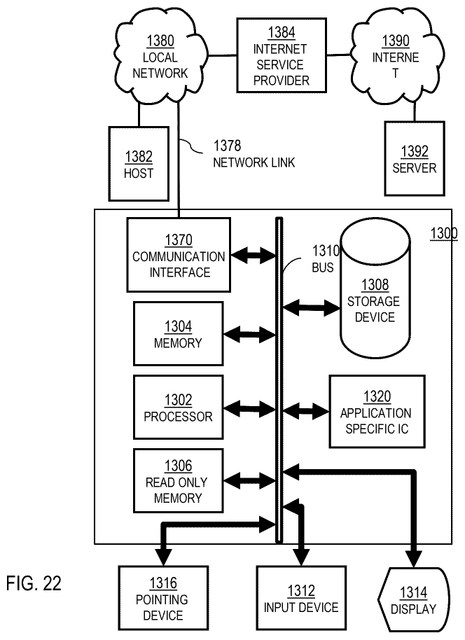

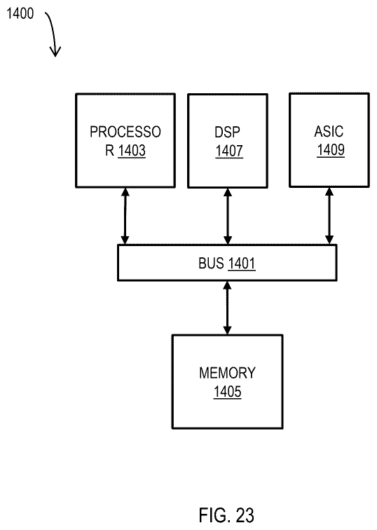

FIG. 21A and FIG. 21B show high-performance liquid chromatography results for a sample reference and a GLS-1027 sample on respective charts of retention time versus height.

The buried extractor target can be used in conjunction with any electrospray process. In addition, the buried extractor target can be used in conjunction with various aspects of electrospray deposition, including applying a negative, positive, or neutral prespray, using with a focus ring, using a shutter, and dissipating surrounding charges.

The Inventors have created an apparatus and method that can improve the deposition efficiency of selectively coated substrates in a simple to implement and inexpensive way. Consequently, this represents an improvement in the art.

### Computational Hardware Overview

FIG. 7 is a block diagram that illustrates a computer system 1300 upon which an embodiment of the invention may be implemented. Computer system 1300 includes a communication mechanism such as a bus 1310 for passing information between other internal and external components of the computer system 1300. Information is represented as physical signals of a measurable phenomenon, typically electric voltages, but including, in other embodiments, such phenomena as magnetic, electromagnetic, pressure, chemical, molecular atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1300, or a portion thereof, constitutes a means for performing one or more steps of one or more methods described herein.

A sequence of binary digits constitutes digital data that is used to represent a number or code for a character. A bus 1310 includes many parallel conductors of information so that information is transferred quickly among devices coupled to the bus 1310. One or more processors 1302 for processing information are coupled with the bus 1310. A processor 1302 performs a set of operations on information. The set of operations include bringing information in from the bus 1310 and placing information on the bus 1310. The set of operations also typically include comparing two or more units of information, shifting positions of units of information, and combining two or more units of information, such as by addition or multiplication. A sequence of operations to be executed by the processor 1302 constitutes computer instructions.

Computer system 1300 also includes a memory 1304 coupled to bus 1310. The memory 1304, such as a random access memory (RAM) or other dynamic storage device, stores information including computer instructions. Dynamic memory allows information stored therein to be changed by the computer system 1300. RAM allows a unit of information stored at a location called a memory address to be stored and retrieved independently of information at neighboring addresses. The memory 1304 is also used by the processor 1302 to store temporary values during execution of computer instructions. The computer system 1300 also includes a read only memory (ROM) 1306 or other static storage device coupled to the bus 1310 for storing static information, including instructions, that is not changed by the computer system 1300. Also coupled to bus 1310 is a non-volatile (persistent) storage device 1308, such as a magnetic disk or optical disk, for storing information, including instructions, that persists even when the computer system 1300 is turned off or otherwise loses power.

Information, including instructions, is provided to the bus 1310 for use by the processor from an external input device 1312, such as a keyboard containing alphanumeric keys operated by a human user, or a sensor. A sensor detects conditions in its vicinity and transforms those detections into signals compatible with the signals used to represent information in computer system 1300. Other external devices coupled to bus 1310, used primarily for interacting with humans, include a display device 1314, such as a cathode ray tube (CRT) or a liquid crystal display (LCD), for presenting images, and a pointing device 1316, such as a mouse or a trackball or cursor direction keys, for controlling a position of a small cursor image presented on the display 1314 and issuing commands associated with graphical elements presented on the display 1314.

In the illustrated embodiment, special purpose hardware, such as an application specific integrated circuit (IC) 1320, is coupled to bus 1310. The special purpose hardware is configured to perform operations not performed by processor 1302 quickly enough for special purposes. Examples of application specific ICs include graphics accelerator cards for generating images for display 1314, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1300 also includes one or more instances of a communications interface 1370 coupled to bus 1310. Communication interface 1370 provides a two-way communication coupling to a variety of external devices that operate with their own processors, such as printers, scanners and external disks. In general the coupling is with a network link 1378 that is connected to a local network 1380 to which a variety of external devices with their own processors are connected. For example, communication interface 1370 may be a parallel port or a serial port or a universal serial bus (USB) port on a personal computer. In some embodiments, communications interface 1370 is an integrated services digital network (ISDN) card or a digital subscriber line (DSL) card or a telephone modem that provides an information communication connection to a corresponding type of telephone line. In some embodiments, a communication interface 1370 is a cable modem that converts signals on bus 1310 into signals for a communication connection over a coaxial cable or into optical signals for a communication connection over a fiber optic cable. As another example, communications interface 1370 may be a local area network (LAN) card to provide a data communication connection to a compatible LAN, such as Ethernet. Wireless links may also be implemented. Carrier waves, such as acoustic waves and electromagnetic waves, including radio, optical and infrared waves travel through space without wires or cables. Signals include man-made variations in amplitude, frequency, phase, polarization or other physical properties of carrier waves. For wireless links, the communications interface 1370 sends and receives electrical, acoustic or electromagnetic signals, including infrared and optical signals, that carry information streams, such as digital data.

The term computer-readable medium is used herein to refer to any medium that participates in providing information to processor 1302, including instructions for execution. Such a medium may take many forms, including, but not limited to, non-volatile media, volatile media and transmission media. Non-volatile media include, for example, optical or magnetic disks, such as storage device 1308. Volatile media include, for example, dynamic memory 1304. Transmission media include, for example, coaxial cables, copper wire, fiber optic cables, and waves that travel through space without wires or cables, such as acoustic waves and electromagnetic waves, including radio, optical and infrared waves. The term computer-readable storage medium is used herein to refer to any medium that participates in providing information to processor 1302, except for transmission media.

Common forms of computer-readable media include, for example, a floppy disk, a flexible disk, a hard disk, a magnetic tape, or any other magnetic medium, a compact disk ROM (CD-ROM), a digital video disk (DVD) or any other optical medium, punch cards, paper tape, or any other physical medium with patterns of holes, a RAM, a programmable ROM (PROM), an erasable PROM (EPROM), a FLASH-EPROM, or any other memory chip or cartridge, a carrier wave, or any other medium from which a computer can read. The term non-transitory computer-readable storage medium is used herein to refer to any medium that participates in providing information to processor 1302, except for carrier waves and other signals.

Logic encoded in one or more tangible media includes one or both of processor instructions on a computer-readable storage media and special purpose hardware, such as ASIC 1320.

Network link 1378 typically provides information communication through one or more networks to other devices that use or process the information. For example, network link 1378 may provide a connection through local network 1380 to a host computer 1382 or to equipment 1384 operated by an Internet Service Provider (ISP). ISP equipment 1384 in turn provides data communication services through the public, world-wide packet-switching communication network of networks now commonly referred to as the Internet 1390. A computer called a server 1392 connected to the Internet provides a service in response to information received over the Internet. For example, server 1392 provides information representing video data for presentation at display 1314.

The invention is related to the use of computer system 1300 for implementing the techniques described herein. According to one embodiment of the invention, those techniques are performed by computer system 1300 in response to processor 1302 executing one or more sequences of one or more instructions contained in memory 1304. Such instructions, also called software and program code, may be read into memory 1304 from another computer-readable medium such as storage device 1308. Execution of the sequences of instructions contained in memory 1304 causes processor 1302 to perform the method steps described herein. In alternative embodiments, hardware, such as application specific integrated circuit 1320, may be used in place of or in combination with software to implement the invention. Thus, embodiments of the invention are not limited to any specific combination of hardware and software.

The signals transmitted over network link 1378 and other networks through communications interface 1370, carry information to and from computer system 1300. Computer system 1300 can send and receive information, including program code, through the networks 1380, 1390 among others, through network link 1378 and communications interface 1370. In an example using the Internet 1390, a server 1392 transmits program code for a particular application, requested by a message sent from computer system 1300, through Internet 1390, ISP equipment 1384, local network 1380 and communications interface 1370. The received code may be executed by processor 1302 as it is received or may be stored in storage device 1308 or other non-volatile storage for later execution, or both. In this manner, computer system 1300 may obtain application program code in the form of a signal on a carrier wave.

Various forms of computer readable media may be involved in carrying one or more sequence of instructions or data or both to processor 1302 for execution. For example, instructions and data may initially be carried on a magnetic disk of a remote computer such as host 1382. The remote computer loads the instructions and data into its dynamic memory and sends the instructions and data over a telephone line using a modem. A modem local to the computer system 1300 receives the instructions and data on a telephone line and uses an infra-red transmitter to convert the instructions and data to a signal on an infra-red a carrier wave serving as the network link 1378. An infrared detector serving as communications interface 1370 receives the instructions and data carried in the infrared signal and places information representing the instructions and data onto bus 1310. Bus 1310 carries the information to memory 1304 from which processor 1302 retrieves and executes the instructions using some of the data sent with the instructions. The instructions and data received in memory 1304 may optionally be stored on storage device 1308, either before or after execution by the processor 1302.

FIG. 8 illustrates a chip set 1400 upon which an embodiment of the invention may be implemented. Chip set 1400 is programmed to perform one or more steps of a method described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1400, or a portion thereof, constitutes a means for performing one or more steps of a method described herein.

In one embodiment, the chip set 1400 includes a communication mechanism such as a bus 1401 for passing information among the components of the chip set 1400. A processor 1403 has connectivity to the bus 1401 to execute instructions and process information stored in, for example, a memory 1405. The processor 1403 may include one or more processing cores with each core configured to perform independently. A multi-core processor enables multiprocessing within a single physical package. Examples of a multi-core processor include two, four, eight, or greater numbers of processing cores. Alternatively, or in addition, the processor 1403 may include one or more microprocessors configured in tandem via the bus 1401 to enable independent execution of instructions, pipelining, and multithreading. The processor 1403 may also be accompanied with one or more specialized components to perform certain processing functions and tasks such as one or more digital signal processors (DSP) 1407, or one or more application-specific integrated circuits (ASIC) 1409. A DSP 1407 typically is configured to process real-world signals (e.g., sound) in real time independently of the processor 1403. Similarly, an ASIC 1409 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1403 and accompanying components have connectivity to the memory 1405 via the bus 1401. The memory 1405 includes both dynamic memory (e.g., RAM, magnetic disk, writable optical disk, etc.) and static memory (e.g., ROM, CD-ROM, etc.) for storing executable instructions that when executed perform one or more steps of a method described herein. The memory 1405 also stores the data associated with or generated by the execution of one or more steps of the methods described herein.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense. Throughout this specification and the claims, unless the context requires otherwise, the word “comprise” and its variations, such as “comprises” and “comprising.” will be understood to imply the inclusion of a stated item, element or step or group of items, elements or steps but not the exclusion of any other item, element or step or group of items, elements or steps. Furthermore, the indefinite article “a” or “an” is meant to indicate one or more of the item, element or step modified by the article.

### REFERENCES

The following are hereby incorporated by reference as if fully set forth herein, except for terminology inconsistent with that used herein.
1. Klein, L. C.; Kallontzi, S.; Fabris, L.; Jitianu, A.; Ryan, C.; Aparicio, M.; Lei, L.; Singer, J. P. Journal of Sol-Gel Science and Technology 2018.
2. Naguib, M.; Mochalin, V. N.; Barsoum, M. W.; Gogotsi, Y. Advanced Materials 2014, 26, (7), 992-1005.
3. Merrill, M. H.; Pogue, I. I. I. W. R.; Baucom, J. N. Journal of Micro and Nano-Manufacturing 2015, 3, (1), 011003-011003.
4. Merrill, M.; Teferra, K.; Kang, W. In Nano-scaled Structures through Charged Particle Interactions, Proceedings of the American Society for Composites: Thirty-First Technical Conference, 2016.
5. Zeleny, J. Physical review 1917, 10, (1), 1.
6. Vonnegut, B.; Neubauer, R. L. Journal of Colloid Science 1952, 7, (6), 616-622.
7. Taylor, G. Proceedings of the Royal Society of London. Series A, Mathematical and Physical Sciences 1964, 280, (1382), 383-397.
8. Yamashita, M.; Fenn, J. B. The Journal of Physical Chemistry 1984, 88, (20), 4451-4459.
9. Blumberg, L. N.; Gursky, J. C.; Stein, P. C., Electrospraying of Thin Targets. Los Alamos Scientific Laboratory: 1962.
10. Wu, S. Polymer-Plastics Technology and Engineering 1976, 7, (2), 119-220.
11. Prasad, L. K.; McGinity, J. W.; Williams, R. O. International Journal of Pharmaceutics 2016, 505, (1), 289-302.
12. Elmoursi, A. A.; Garner, D. P. J. Coat. Technol. 1992, 64, (805), 39-44.
13. Tachi, K.; Okuda, C.; Yamada, K. J. Coat. Technol. 1990, 62, (791), 19-25.
14. Bailey, A. G. Journal of Electrostatics 1998, 45, (2), 85-120.
15. Edward Law, S. Journal of Electrostatics 2001, 51-52, 25-42.
16. Gaskell, S. J. Journal of mass spectrometry 1997, 32, (7), 677-688.
17. Jaworek, A.; Sobczyk, A. T. Journal of Electrostatics 2008, 66, (3-4), 197-219.
18. Subbiah, T.; Bhat, G. S.; Tock, R. W.; Parameswaran, S.; Ramkumar, S. S. Journal of Applied Polymer Science 2005, 96, (2), 557-569.
19. Gomez, A.; Tang, K. Physics of Fluids 1994, 6, (1), 404-414.
20. Gañán-Calvo, A. M.; Dávila, J.; Barrero, A. Journal of Aerosol Science 1997, 28, (2), 249-275.
21. Moerman, R.; Frank, J.; Marijnissen, J. C. M.; Schalkhammer, T. G. M.; van Dedem, G. W. K. Analytical Chemistry 2001, 73, (10), 2183-2189.
22. Hinaut, A.; Pawlak, R.; Meyer, E.; Glatzel, T. Beilstein Journal of Nanotechnology 2015, 6, 1927-1934.
23. Woo, C. G.; Shin, H.; Jeong, C.; Jun, K.; Lee, J.; Lee, J.-R.; Lee, H.; You, S.; Son, Y.; Choi, M. Small 2011, 7, (13), 1790-1794.
24. Hu, H.; Singer, J. P.; Osuji, C. O. Macromolecules 2014, 47, (16), 5703-5710.
25. Choo, Y.; Hu, H.; Toth, K.; Osuji, C. O. Journal of Polymer Science Part B: Polymer Physics 2016, 54, (2), 247-253.
26. Hu, H.; Toth, K.; Kim, M.; Gopalan, P.; Osuji, C. O. MRS Communications 2015, 5, (2), 235-242.
27. Kim, J.-S.; Chung, W.-S.; Kim, K.; Kim, D. Y.; Paeng, K.-J.; Jo, S. M.; Jang, S.-Y. Advanced Functional Materials 2010, 20, (20), 3538-3546.
28. Rietveld, I. B.; Kobayashi, K.; Yamada, H.; Matsushige, K. Soft Matter 2009, 5, (3), 593-598.
29. Weiss, F. M.; Topper, T.; Osmani, B.; Peters, S.; Kovacs, G.; Muller, B. Adv. Electron. Mater. 2016, 2, (5), 8.
30. Guo, Q.; Mather, J. P.; Yang, P.; Boden, M.; Mather, P. T. PLOS ONE 2015, 10, (6), e0129960.
31. Rietveld, I. B.; Kobayashi, K.; Yamada, H.; Matsushige, K. Journal of Colloid and Interface Science 2006, 298, (2), 639-651.
32. Novak, S.; Johnston, D. E.; Li, C.; Deng, W.; Richardson, K. Thin Solid Films 2015, 588, 56-60.
33. Chavhan, M. P.; Ganguly, S. Industrial & Engineering Chemistry Research 2016, 55, (38), 10073-10083.
34. Leeuwenburgh, S.; Wolke, J.; Schoonman, J.; Jansen, J. Journal of Biomedical Materials Research Part A 2003, 66A, (2), 330-334.
35. Kim, J.-Y.; Kim, E.-K.; Kim, S. S. Journal of Colloid and Interface Science 2013, 392, 376-381.
36. Kim, J. W.; Yamagata, Y.; Kim, B. J.; Higuchi, T. Journal of Micromechanics and Microengineering 2009, 19, (2), 025021.
37. Al-Milaji, K. N.; Zhao, H. Applied Surface Science 2017, 396, 955-964.
38. Burkarter, E.; Saul, C. K.; Thomazi, F.; Cruz, N. C.; Roman, L. S.; Schreiner, W. H. Surface and Coatings Technology 2007, 202, (1), 194-198.
39. Hou, X.; Choy, K.-L. Surface and Coatings Technology 2004, 180-181, 15-19.
40. Krella, A. K.; Sobczyk, A. T.; Krupa, A.; Jaworek, A. Mechanics of Materials 2016, 98, 120-133.
41. Hwang, D.; Lee, H.; Jang, S.-Y.; Jo, S. M.; Kim, D.; Seo, Y.; Kim, D. Y. ACS Applied Materials & Interfaces 2011, 3, (7), 2719-2725.
42. Li, Q.; Church, J. S.; Naebe, M.; Fox, B. L. Composites Part A: Applied Science and Manufacturing 2016, 90, 174-185.
43. Tang, J.; Gomez, A. Aerosol Science and Technology 2017, 51, (6), 755-765.
44. Lei, L.; Kovacevich, D. A.; Nitzsche, M. P.; Ryu, J.; Al-Marzoki, K.; Rodriguez, G.; Klein, L. C.; Jitianu, A.; Singer, J. P. ACS Applied Materials & Interfaces 2018, 10, (13), 11175-11188.
45. Cazaux, J. Journal of Electrostatics 2007, 65, (12), 764-774.
46. Hoburg, J. F. IEEE Transactions on Industry Applications 1982, (6), 666-672.
47. Bodnár, E.; Rosell-Llompart, J. Journal of Colloid and Interface Science 2013, 407, (0), 536-545.
48. Hoang, A.; Pallon, L.; Liu, D.; Serdyuk, Y.; Gubanski, S.; Gedde, U. Polymers 2016, 8, (3), 87.
49. A., N. F.; Alexandra, P.; F., K. B. A.; Martin, D.; Markus, R. Advanced Materials 2018, 30, (14), 1704910.
50. Tang, K.; Gomez, A. Physics of Fluids 1994, 6, (7), 2317-2332.
51. Freeman, P.; Rowlinson, J. Polymer 1960, 1, 20-26.
52. Kay, D.; Styles, V.; Welford, R. Interfaces Free Bound 2008, 10, (1), 15-43.
53. Brown, E.; Zhang, H.; Forman, N. A.; Maynor, B. W.; Betts, D. E.; DeSimone, J. M.; Jaeger, H. M. Physical Review E 2011, 84, (3), 031408.
54. Bertrand, E.; Bibette, J.; Schmitt, V. Physical Review E 2002, 66, (6), 060401.
55. Banerjee, P.; Mandal, B. M. Macromolecules 1995, 28, (11), 3940-3943.
56. Park, M.; Im, J.; Shin, M.; Min, Y.; Park, J.; Cho, H.; Park, S.; Shim, M.-B.; Jeon, S.; Chung, D.-Y.; Bae, J.; Park, J.; Jeong, U.; Kim, K. Nat Nano 2012, 7, (12), 803-809.
57. Kim, Y.; Zhu, J.; Yeom, B.; Di Prima, M.; Su, X.; Kim, J.-G.; Yoo, S. J.; Uher, C.; Kotov, N. A. Nature 2013, 500, (7460), 59-63.
58. Balazs, A. C.; Emrick, T.; Russell, T. P. Science 2006, 314, (5802), 1107-1110.
59. Li, J.; Kim, J.-K. Composites Science and Technology 2007, 67, (10), 2114-2120.
60. Wang, Y.; Shan, J. W.; Weng, G. J. Journal of Applied Physics 2015, 118, (6), 065101.
61. Dhawan, S. K.; Singh, N.; Venkatachalam, S. Synthetic Metals 2001, 125, (3), 389-393.
62. Coleman, J. N.; Curran, S.; Dalton, A. B.; Davey, A. P.; Mccarthy, B.; Blau, W.; Barklie, R. C. Physical Review B 1998, 58, (12), R7492-R7495.
63. Winey, K. I.; Kashiwagi, T.; Mu, M. Mrs Bulletin 2007, 32, (4), 348-353.
64. Powell, M. Physical Review B 1979, 20, (10), 4194.
65. Narkis, M.; Lidor, G.; Vaxman, A.; Zuri, L. Journal of Electrostatics 1999, 47, (4), 201-214.
66. Kitano, M.; Shiojiri, M. Powder Technology 1997, 93, (3), 267-273.
67. Kuhn, H. H., Characterization and Application of Polypyrrole-Coated Textiles. In Intrinsically Conducting Polymers: An Emerging Technology, Aldissi, M., Ed. Springer Netherlands: Dordrecht, 1993; pp 25-34.
68. Maleski, K.; Mochalin, V. N.; Gogotsi, Y. Chemistry of Materials 2017, 29, (4), 1632-1640.
69. Sprik, M.; Delamarche, E.; Michel, B.; Roethlisberger, U.; Klein, M. L.; Wolf, H.; Ringsdorf, H. Langmuir 1994, 10, (11), 4116-4130.
70. Lee, J.; Bong, J.; Ha, Y.-G.; Park, S.; Ju, S. Applied Surface Science 2015, 330, 445-448.
71. Kanta, A.; Sedev, R.; Ralston, J. Colloids and Surfaces A: Physicochemical and Engineering Aspects 2006, 291, (1), 51-58.
72. Kataby, G.; Prozorov, T.; Koltypin, Y.; Cohen, H.; Sukenik, C. N.; Ulman, A.; Gedanken, A. Langmuir 1997, 13, (23), 6151-6158.
73. Hoque, E.; DeRose, J. A.; Houriet, R.; Hoffmann, P.; Mathieu, H. J. Chemistry of Materials 2007, 19, (4), 798-804.
74. Kay, D.; Styles, V.; Welford. R Interfaces Free Bound 10.1 (2008): 15-43.
75. High-Efficiency Electrospray Deposition Method for Nonconductive Substrates: Applications of Superhydrophobic Coatings. Md. Khalilur Rahman, et al. ACS Appl. Mater. Interfaces 2021, 13, 15, 18227-18236.
76. Self-Limiting Electrospray Deposition on Polymer Templates. Jonathan Singer, et al. Scientific Reports volume 10, Article number: 17290 (2020).
77. Electrospray Printing of Polyimide Films Using Passive Material Focusing. Bryce Kingsley, et al. ACS Appl. Polym. Mater. 2021, 3, 6274-6284.
78. Determining the Self-Limiting Electrospray Deposition Compositional Limits for Mechanically Tunable Polymer Composites. Jonathan Singer, et al. ChemRxiv 2021.
79. Experimental Design and Instability Analysis of Coaxial Electrospray Process For Microencapsulation Of Drugs And Imaging Agents. Ting Si, et al. Journal of Biomedical Optics 2013, 18 (7): 75003.
80. Continuous Equilibrated Growth of Ordered Block Copolymer Thin Films By Electrospray Deposition. Chinedum Osuji, et al. ACS Nano. 2013, 7 (4), 2960-2970
81. Morozov, V. N. and T. Y. Morozova (1999). “Electrospray Deposition as a Method for Mass Fabrication of Mono- and Multicomponent Microarrays of Biological and Biologically Active Substances.” Analytical Chemistry 71 (15): 3110-3117.
82. Blumberg. L. N., et al. (1962). Electrospraying of Thin Targets, Los Alamos Scientific Laboratory.
83. Lei. L., et al. (2018). “Obtaining Thickness-Limited Electrospray Deposition for 3D Coating.” ACS Appl Mater Interfaces 10 (13): 11175-11188.
84. Toth, K., Osuji, C. O., Yager, K. G. & Doerk, G. S. Comprehensive study on electrospray deposition in the single Taylor cone-jet mode by changing the spatial electric potential using a ring-shaped ternary electrode. Rev Sci Instrum 91, 013701, doi:10.1063/1.5129625 (2020).
85. Jaworek, A., Sobczyk, A. T. & Krupa, A. Electrospray application to powder production and surface coating. Journal of Aerosol Science 125, 57-92, doi: https://doi.org/10.1016/j.jaerosci.2018.04.006 (2018).
86. Jaworek, A. & Krupa, A. Generation and characteristics of the precession mode of EHD spraying. Journal of Aerosol Science 27, 75-82 (1995).
87. Brown, N. A., et al. (2017). “Structure of Electrospray Printed Deposits for Short Spray Times.” Journal of Micro and Nano-Manufacturing 5 (4).
88. Kudoh, Y., et al. (2014). “Control of the pretilt angle for liquid crystal alignment using novel electrospray deposition methods with two capillaries.” Journal of the Society for Information Display 22 (7): 357-363.
89. Rietveld, I. B., et al. (2008). “Electrospray Deposition of Photoresist: A Low Impact Method for the Fabrication of Multilayered Films.” Macromolecular Materials and Engineering 293 (5): 387-399.
0. Arya, J.; Prausnitz, M. R. Microneedle Patches for Vaccination in Developing Countries. J. Controlled Release 2016, 240, 135-141.
91. Lei, L.; Gamboa, A. R.; Kuznetsova, C.; Littlecreek, S.; Wang, J.: Zou, Q.: Zahn, J. D.; Singer, J. P Scientific Reports, 2020, 10, 17290
92. Shlyapnikov, M. Y., Shlyapnikova, A. E., Morozov, N. V., Anal. Chem., 2016, 88 (14), pp 7295-7301.
93. Morozov, V. N. Electrospray Deposition of Biomolecules. Adv Biochem Eng Biotechnol 119, 115-162 (2009).
94. Fukuda, T., Toda, A., Takahira, K., Kuzuhara, D. & Yoshimoto, N. Improved performance of organic photovoltaic cells with PTB7-Th: PC71 BM by optimized solvent evaporation time in electrospray deposition. Organic Electronics 48, 96-105, doi:10.1016/j.orgel.2017.05.049 (2017).
95. Fukuda, T. et al. Improved Power Conversion Efficiency of Organic Photovoltaic Cell Fabricated by Electrospray Deposition Method by Mixing Different Solvents. Japanese Journal of Applied Physics 51, doi:10.1143/jjap.51.02bk12 (2012).
96. Ju. J, Yamagata, Y. & Higuchi, T. Thin-Film Fabrication Method for Organic Light-Emitting Diodes Using Electrospray Deposition. Advanced Materials 21 (2009).
97. Zhang, S. & Kawakami, K. One-step preparation of chitosan solid nanoparticles by electrospray deposition. Int J Pharm 397, 211-217, doi:10.1016/j.ijpharm.2010.07.007 (2010).
98. Nagarajan, U., Kawakami, K., Zhang, S., Chandrasekaran, B. & Nair, B. U. Fabrication of Solid Collagen Nanoparticles Using Electrospray Deposition. Chemical and Pharmaceutical Bulletin 62, 422-428 (2014).
99. Lee, S. J., Park, S. M., Han, S. J. & Kim, D. S. Electrolyte solution-assisted electrospray deposition for direct coating and patterning of polymeric nanoparticles on nonconductive surfaces. Chemical Engineering Journal 379, doi:10.1016/j.cej.2019.122318 (2020).
100. de Jonge, L. T. et al. The osteogenic effect of electrosprayed nanoscale collagen/calcium phosphate coatings on titanium. Biomaterials 31, 2461-2469, doi:10.1016/j.biomaterials.2009.11.114 (2010).
101. Müller, V., Jobbagy, M. & Djurado, E. Coupling sol-gel with electrospray deposition: Towards nanotextured bioactive glass coatings. Journal of the European Ceramic Society 41, 7288-7300, doi:10.1016/j.jeurceramsoc.2021.07.041 (2021).
102. Gomez, A., Binghamd, D., de Juan, L. & Tang, K. Production of protein nanoparticles by electrospray drying. Journal of Aerosol Science 29, 561-574 (1998).
103. Morozov, V. N. & Morozov, T. Y. Electrospray Deposition as a Method To Fabricate Functionally Active Protein Films. Analytical Chemistry 71, 1415-1420 (1999).
104. Kovacevich, D. A. et al. Self-Limiting Electrospray Deposition for the Surface Modification of Additively Manufactured Parts. ACS Applied Materials & Interfaces 12, 20901-20911, doi: https://doi.org/10.1021/acsami.9b23544 (2020).
105. Jaworek, A. Electrospray droplet sources for thin film deposition. Journal of Materials Science 42, 266-297, doi:10.1007/s10853-006-0842-9 (2006).
106. Jaworek, A. & Sobczyk, A. T. Electrospraying route to nanotechnology: An overview. Journal of Electrostatics 66, 197-219, doi:10.1016/j.elstat.2007.10.001 (2007).
107. Altmann, K., Schulze, R. D., Hidde, G. & Friedrich, J. Electrospray ionization for deposition of ultra-thin polymer layers-principle, electrophoretic effect and applications. J. Adhes. Sci. Technol. 27, 988-1005, doi:10.1080/01694243.2012.727170 (2013).
108. Zhu, Y. & Chiarot, P. R. Surface charge accumulation and decay in electrospray printing. J. Phys. D: Appl. Phys. 54, 075301, doi:10.1088/1361-6463/abc449 (2020).
109. Lei, L. et al. Homogeneous gelation leads to nanowire forests in the transition between electrospray and electrospinning. Materials Horizons 7, 2643-2650, doi:10.1039/d0mh00872a (2020).
110. Toth, K., Osuji, C. O., Yager, K. G. & Doerk, G. S. Comprehensive study on electrospray deposition in the single Taylor cone-jet mode by changing the spatial electric potential using a ring-shaped ternary electrode. Rev Sci Instrum 91, 013701, doi:10.1063/1.5129625 (2020).
112. Gill, H. S. & Prausnitz, M. R. Coating formulations for microneedles. Pharm Res 24, 1369-1380, doi:10.1007/s11095-007-9286-4 (2007).
113. Kim, Y. C., Quan, F. S., Compans, R. W., Kang, S. M. & Prausnitz, M. R. Stability kinetics of influenza vaccine coated onto microneedles during drying and storage. Pharm Res 28, 135-144, doi:10.1007/s11095-010-0134-6 (2011).
114. Arya, J. & Prausnitz, M. R. Microneedle patches for vaccination in developing countries. J Control Release 240, 135-141, doi:10.1016/j.jconrel.2015.11.019 (2016).
115. Bodnár, E. & Rosell-Llompart, J. Growth dynamics of granular films produced by electrospray. Journal of Colloid and Interface Science 407, 536-545, doi: http://dx.doi.org/10.1016/j.jcis.2013.06.013 (2013).
116. Ingrole, R. S. J.; Gill, H. S. J. Pharmacol. Exp. Ther. 2019, 370 (3), 555-569.
117. X. Cheng, I. I. D. G. Camp, Q. Wu, R. Bakhtiar, D. L. Springer, B. J. Morris, J. E. Bruce, G. A. Anderson, C. G. Edmonds, R. D. Smith, Nucleic Acids Res. 1996, 24, 2183.

What is claimed is:

1. A method, comprising:
establishing an electric field in an electrospray deposition device and within the electric field emitting a spray of a medium comprising payload materials from an emitter toward a conductive target disposed on an insulated conductive body;
disposing charged payload materials on the insulated conductive body; and
establishing field lines in the electric field between the emitter and the charged payload materials on the insulated conductive body to stabilize the electric field and between the emitter and the target to carry the spray of the medium to the target.

2. The method of claim 1, further comprising disposing the charged payload materials on the insulated conductive body by causing an initial overspray of the medium comprising the charged payload materials to reach the insulated conductive body.

3. The method of claim 1, further comprising ensuring insulation on the insulated conductive body permits field lines to form between the charged payload materials on the insulated conductive body and a conductive body of the insulated conductive body when the electric field is present.

4. The method of claim 3, further comprising holding the conductive body at a relatively lower or higher potential difference with the emitter as compared to the target.

5. The method of claim 4, further comprising grounding the conductive body.

6. The method of claim 1, further comprising ensuring that field lines between the emitter and the charged payload materials on the insulated conductive body fully surround the target.

7. The method of claim 1, further comprising directing the spray of the medium with the field lines between the emitter and the target.

8. The method of claim 1, further comprising applying a mask to a portion of the target.

9. The method of claim 8, further comprising:
aligning the spray of the medium with the field lines between the emitter and the target; and
ensuring that field lines between the emitter and the mask are less dense than field lines between the emitter and the charged payload materials on the insulated conductive body to: 1) isolate the field lines between the emitter and an unmasked portion of the target from other field lines; 2) aid in concentrating the spray of the medium within the field lines between the emitter and the unmasked portion of the target; and 3) thereby focus the spray of the medium on the unmasked portion of the target.

10. The method of claim 1, further comprising ensuring a mass of a conductive body of the insulated conductive body is at least 1,000 times a mass of the target.

11. A method, comprising:
establishing an electric field in an electrospray deposition apparatus between an emitter and an insulated conductive body;
disposing a target on the insulated conductive body;
emitting a spray of a medium toward the target; and
causing an initial overspray of the spray to reach the insulated conductive body.

12. The method of claim 11, further comprising causing the initial overspray to reach a mask on the target.

13. The method of claim 11, wherein the insulated conductive body establishes an insulated body profile as seen by the emitter; the method further comprising ensuring the target is disposed fully within the insulated body profile as seen by the emitter.

14. The method of claim 13, further comprising maintaining a distance of at least 1 centimeter between the target as seen by the emitter and an entirety of a perimeter of the insulated body profile.

15. The method of claim 13, wherein the insulated body profile establishes an insulated body profile area; wherein the target establishes a target profile as seen by the emitter; and wherein the target profile establishes a target profile area; the method further comprising ensuring the insulated body profile area is at least 100 times the target profile area.

16. The method of claim 11, further comprising ensuring a mass of a conductive body of the insulated conductive body is at least 1000 times a mass of the target.

17. A method, comprising:
subjecting a flow of a medium from a capillary to a relatively high electric field to form a spray of droplets of the medium;
directing the spray toward a target disposed on an insulated surface that is disposed on a conductive body that is held at an electrical potential difference with the medium in the capillary;
causing initial overspray of the spray; and
ensuring the initial overspray lands on the insulated surface adjacent the target.

18. The method of claim 17, further comprising ensuring the initial overspray surrounds around an entire perimeter of the target.

19. The method of claim 17, further comprising ensuring the initial overspray is disposed in the electric field generated by the relatively high potential difference.

20. The method of claim 19, wherein the potential difference results from a grounded body.

21. The method of claim 17, further comprising applying an insulating mask to a portion of the target.

22. The method of claim 17, further comprising applying a prespray to the target and the insulated surface to dissipate or apply charge.

23. The method of claim 17, further comprising focusing the spray using a focus ring disposed around the spray.

24. An apparatus, comprising:
an electrospray deposition emitter configured to generate a spray of a medium toward a target and to be held at or above a first electric potential magnitude; and
an extractor target comprising: an electrically conductive body configured to be held at a lower or higher electric potential magnitude than the first electric potential magnitude and to define a support face; insulation on the support face; and electrically charged payload materials disposed on the support face.

25. The apparatus of claim 24, wherein the first potential is configured to generate an electric field, and wherein the electric field is sufficient to cause the field lines to form between the electrically charged payload materials and the electrically conductive body.

26. The apparatus of claim 24, wherein the electrically conductive body is grounded.

27. The apparatus of claim 24, further comprising a focus ring configured to constrict the spray radially inward as the spray passes through the focus ring.

28. The apparatus of claim 24, further comprising a controller configured to control at least one of the first potential and a flow rate of the medium.

29. An apparatus, comprising:
a capillary configured to pass emit therefrom a flow of a medium;
an extractor target comprising an electrically conductive body configured to define a support face facing the capillary, and insulation on the support face; and
a high voltage source configured to generate an electric potential that will disperse the flow exiting the capillary into a spray of charged droplets directed toward the support face; and configured to generate an electric field between the capillary and a target on the support face at a different electric potential;
wherein the electrically conductive body of the extractor target is configured to be held at an electrical potential that is below a relatively high voltage generated by the high voltage source.

30. The apparatus of claim 29, further configured to cause an initial overspray of the spray to reach the support face;
wherein the electric field is configured to generate field lines between the capillary and medium from the initial overspray disposed on the support face.

31. The apparatus of claim 29, wherein the electrically conductive body is grounded.

32. The apparatus of claim 29, further comprising a focus ring configured to constrict the spray radially inward as the spray passes through the focus ring.

33. The apparatus of claim 29, further comprising a controller configured to control the generation of at least one of the electric field and a flow rate of the medium.
